(19) United States
(12) Patent Application Publication
(10) Pub. No.: US 2024/0403528 A1
(43) Pub. Date: Dec. 5, 2024

(54) SEMICONDUCTOR INTEGRATED CIRCUIT EVALUATION METHOD

(71) Applicant: ROHM CO., LTD., Kyoto-shi (JP)

(72) Inventor: Ryosuke INAGAKI, Kyoto-shi (JP)

(21) Appl. No.: 18/799,402

(22) Filed: Aug. 9, 2024

Related U.S. Application Data
(63) Continuation of application No. PCT/JP2022/045457, filed on Dec. 9, 2022.

(30) Foreign Application Priority Data
Feb. 16, 2022 (JP) 2022-022084

(51) Int. Cl. G06F 30/367; G06F 119/10

(52) U.S. Cl. CPC G06F 30/367; G06F 2119/10

(57) ABSTRACT

A semiconductor integrated circuit evaluation method includes an initial setting flow for obtaining a difference correction value from a measured value and a calculated value of unwanted radiation in a semiconductor integrated circuit before implementation of an electromagnetic compatibility countermeasure, and a calculated prediction flow for obtaining a calculated value of unwanted radiation in a semiconductor integrated circuit after implementation of an electromagnetic compatibility countermeasure, correcting the calculated value with the difference correction value, and evaluating whether or not a corrected calculated value conforms to a standard. The initial setting flow and the calculated prediction flow respectively include a step of applying noise elimination processing to the measured value and the calculated value of the unwanted radiation.

### CROSS-REFERENCE TO RELATED APPLICATIONS

This application is a continuation under 35 U.S.C. § 120 of PCT/JP2022/045457, filed Dec. 9, 2022, which is incorporated herein by reference, and which claimed priority to Japanese Application No. 2022-022084, filed Feb. 16, 2022. The present application likewise claims priority under 35 U.S.C. § 119 to Japanese Application No. 2022-022084, filed Feb. 16, 2022, the entire content of which is also incorporated herein by reference.

### TECHNICAL FIELD

The disclosure herein relates to a semiconductor integrated circuit evaluation method.

### BACKGROUND ART

On the designing stage of semiconductor integrated circuits, they need to be evaluated for conformity of their electromagnetic compatibility (EMC) characteristics with a standard value.

An example of conventional technologies related to the above is disclosed in Patent Document 1 identified below.

### CITATION LIST

### Patent Literature

Patent Document 1: JP-A-2017-68492

### Non-Patent Literature

Non-Patent Document 1: Written by Ryousuke Inagaki, ROHM Co., Ltd., “The Design Technologies Series-Semiconductors Enhancing Product Reliability-EMC Design of LSI,” published by Kagakujyoho Shuppan Co., Ltd., ISBN 978-904774-68-7, first published on Feb. 26, 2018, Chapter 6: “Electromagnetic Compatibility Verification of Semiconductor Integrated Circuits by Phenomenon (2),” pp. 137-166
Non-Patent Document 2: Inagaki Rhousuke, “Electromagnetic Environmental Engineering EMC (Monthly EMC)” Power Semiconductor Device for High Current Operation and EMC (2), Calculated Prediction Technique for Electromagnetic Compatibility Verification of Insulated Gate Bipolar Transistor (IGBT)-equipped Intelligent Power Module (IPM) (2), published by Kagakujyoho Shuppan Co., Ltd., December 2020 Issue, No. 392, p. 40-49

### BRIEF DESCRIPTION OF DRAWINGS

FIG. 1 is a conceptual diagram of data assimilation.

FIG. 2 is a diagram illustrating an application example of data assimilation (typhoon course forecast).

FIG. 3 is a flowchart until the achievement of conformity with an electromagnetic compatibility (EMC) standard.

FIG. 4 is a diagram illustrating a concept of computer model (DPS) based on a measured value.

FIG. 5 is a diagram illustrating calculation of a difference collection value (DCV) DELTA0.

FIG. 6 is a diagram illustrating a calculation concept of optimization (Optimization).

FIG. 7 is a diagram illustrating a calculation concept of calculated prediction (Prediction).

FIG. 8 is a diagram illustrating a calculation concept of a malfunction threshold (IB) model.

FIG. 9 is a diagram illustrating a calculation concept of initial setting (Initialization).

FIG. 10 is a diagram illustrating a calculation concept of calculated prediction (Prediction).

FIG. 11 is a flowchart of calculation verification of conducted emission (CE).

FIG. 12 is a verification circuit diagram for circuit analysis of conducted emission (CE).

FIG. 13 is a diagram illustrating an example of initial setting of conducted emission (CE) (intermittent (switching) power supply_before implementation of electromagnetic compatibility (EMC) countermeasure).

FIG. 14 is a diagram illustrating an example of calculated prediction of conducted emission (CE) (intermittent (switching) power supply_after implementation of electromagnetic compatibility (EMC) countermeasure).

FIG. 15 is a flowchart of calculation verification of radiated emission (RE).

FIG. 16 is a verification circuit diagram for circuit analysis of radiated emission (RE).

FIG. 17 is a verification circuit board diagram for electromagnetic field analysis of radiated emission (RE).

FIG. 18 is a diagram illustrating an example of initial setting of radiated emission (RE) (intermittent (switching) power supply_before implementation of electromagnetic compatibility (EMC) countermeasure).

FIG. 19 is a diagram illustrating an example of calculated prediction of radiated emission (RE) (intermittent (switching) power supply_after implementation of electromagnetic compatibility (EMC) countermeasure).

FIG. 20 is a flowchart of calculation verification of conducted immunity (CI).

FIG. 21 is a verification circuit diagram for circuit analysis of conducted immunity (CI).

FIG. 22 is a diagram illustrating an example of initial setting of conducted immunity (CI) (microcomputer, before implementation of electromagnetic compatibility (EMC) countermeasure).

FIG. 23 is a diagram illustrating an example of calculated prediction of conducted immunity (CI) (microcomputer, after implementation of electromagnetic compatibility (EMC) countermeasure).

FIG. 24 is a flowchart of calculation verification of radiated immunity (RI).

FIG. 25 is a verification circuit diagram for circuit analysis of radiated immunity (RI).

FIG. 26 is a verification circuit board diagram for electromagnetic field analysis of radiated immunity (RI).

FIG. 27 is a diagram illustrating a first example of initial setting of radiated immunity (RI) (differential operational amplifier, before implementation of electromagnetic compatibility (EMC) countermeasure, horizontal).

FIG. 28 is a diagram illustrating a second example of initial setting of radiated immunity (RI) (differential operational amplifier, before implementation of electromagnetic compatibility (EMC) countermeasure, vertical).

FIG. 29 is a diagram illustrating a first example of calculated prediction of radiated immunity (RI) (differential operational amplifier, before implementation of electromagnetic compatibility (EMC) countermeasure, horizontal).

FIG. 30 is a diagram illustrating a second example of calculated prediction of radiated immunity (RI) (differential operational amplifier, before implementation of electromagnetic compatibility (EMC) countermeasure, vertical).

FIG. 31 is a flowchart illustrating an example of an evaluation method for semiconductor integrated circuits.

FIG. 32 is a diagram (linear scale) illustrating an example of noise elimination with respect to a measured value without an electromagnetic compatibility (EMC) countermeasure.

FIG. 33 is a diagram (linear scale) illustrating an example of noise elimination with respect to a measured value without an electromagnetic compatibility (EMC) countermeasure.

FIG. 34 is a diagram (logarithmic scale) illustrating an example of noise elimination with respect to a measured value without an electromagnetic compatibility (EMC) countermeasure.

FIG. 35 is a diagram (linear scale) illustrating an example of noise elimination with respect to a calculated value without an electromagnetic compatibility (EMC) countermeasure.

FIG. 36 is a diagram (linear scale) illustrating an example of noise elimination with respect to a calculated value without an electromagnetic compatibility (EMC) countermeasure.

FIG. 37 is a diagram (logarithmic scale) illustrating an example of noise elimination with respect to a calculated value without an electromagnetic compatibility (EMC) countermeasure.

FIG. 38 is a diagram illustrating selection of frequencies from measured values from which noise has been eliminated.

FIG. 39 is a diagram illustrating a calculated value (without difference correction) without an electromagnetic compatibility (EMC) countermeasure.

FIG. 40 is a diagram illustrating a measured value and a calculated value (without difference correction) without an electromagnetic compatibility (EMC) countermeasure.

FIG. 41 is a diagram illustrating difference correction values (=a calculated value-a measured value).

FIG. 42 is a diagram illustrating a measured value and a calculated value (with difference correction) without an electromagnetic compatibility (EMC) countermeasure.

FIG. 43 is a diagram illustrating a calculated value (without difference correction) with an electromagnetic compatibility (EMC) countermeasure.

FIG. 44 is a diagram (linear scale) illustrating an example of noise elimination with respect to a calculated value with an electromagnetic compatibility (EMC) countermeasure.

FIG. 45 is a diagram (logarithmic scale) illustrating an example of noise elimination with respect to a calculated value with an electromagnetic compatibility (EMC) countermeasure.

FIG. 46 is a diagram illustrating a measured value and a calculated value (without difference correction) with an electromagnetic compatibility (EMC) countermeasure.

FIG. 47 is a diagram illustrating a measured value and a calculated value (with difference correction) with an electromagnetic compatibility (EMC) countermeasure.

FIG. 48 is a diagram illustrating a measured value and a calculated value (with difference correction) without noise elimination processing.

FIG. 49 is a diagram illustrating a measured value and a calculated value (with difference correction) with noise elimination processing.

FIG. 50 is a diagram schematically illustrating an evaluation board for electromagnetic compatibility (EMC) characteristics.

FIG. 51 is a block diagram of an electromagnetic compatibility (EMC) verification program.

### DESCRIPTION OF EMBODIMENTS

### <Electromagnetic Compatibility Verification for Semiconductor Integrated Circuit by Phenomenon>

Introduced below is a specific example of calculated prediction of electromagnetic compatibility (EMC: Electromagnetic Compatibility) verification by phenomenon in a current semiconductor integrated circuit (LSI: Large Scale Integrated Circuit) product, along with descriptions of the technique and the method thereof. A common piece of EDA (Electronic Design Automation) software is used as a calculation engine, and, without making complex settings using macro language descriptions or script language descriptions, calculated prediction results of electromagnetic compatibility (EMC) characteristics are obtained easily.

Here, a new method for verifying electromagnetic compatibility (EMC) will be tested and proposed. To obtain a calculated prediction value, a measured value is used. By setting a true value or by limiting the target of calculation, it is possible to obtain a good perspective for overall calculated prediction and thus to achieve improvement in both accuracy and speed of calculation. The target of calculation for verifying electromagnetic compatibility (EMC) is not an entire electronic/electrical product, but a single item of semiconductor integrated circuit (LSI), its application circuit, and a printed circuit board (PCB: Printed Circuit Board) for evaluation are the targets of calculation.

### <Outline of Calculated Prediction Technique>

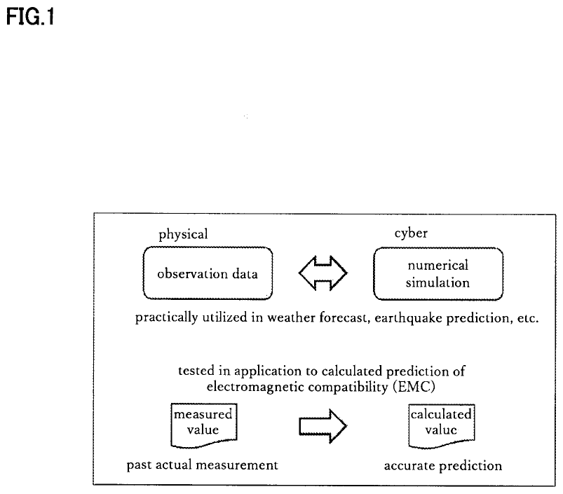

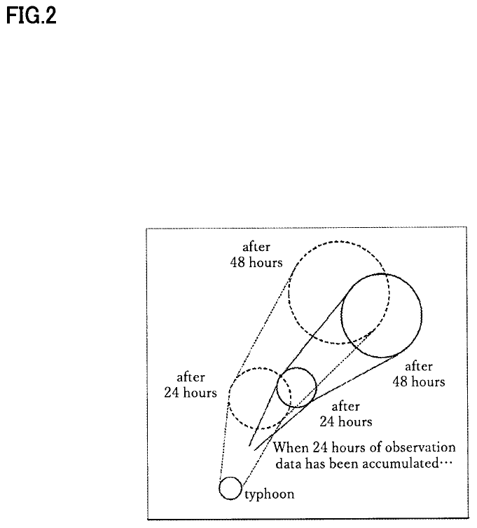

It is the concept of “data assimilation (Data Assimilation)” that the Japan Meteorological Agency of the Ministry of Land, Infrastructure, Transport and Tourism, the Institute of Physical and Chemical Research, which is a national research and development agency, the Institute of Statistical Mathematics of the Research Organization of Information and Systems, which is an inter-university research institute corporation, the Earthquake Research Institute of University of Tokyo, which is a national university corporation, etc. have been advancing in research, development, and implementation. Through mutual use between observation data and numerical simulations, accuracy of calculated prediction is improved. Calculations are performed on the basis of Bayes' theorem (Bayes' Theorem) in Bayesian statistics. The field of weather forecast or earthquake prediction, for example, is the main target of application. These concepts will be applied and tested with respect to the calculated prediction of electromagnetic compatibility (EMC) (see FIG. 1, FIG. 2).

### <Calculated Prediction of Electromagnetic Compatibility (EMC) Characteristics>

A flow until a semiconductor integrated circuit (LSI) and an application circuit thereof conform to an electromagnetic compatibility (EMC) standard. A classic method for it will be first introduced.

As a first stage, calculation is performed with respect to a circuit before implementation of an electromagnetic compatibility (EMC) countermeasure. A semiconductor integrated circuit (LSI) model employs PWL (Piecewise Linear) waveform description based on circuit calculation, and a passive component model (a resistive element, a capacitive element, inductive element, etc.) to be mounted on a printed circuit board (PCB) has SPICE (Simulation Program with Integrated Circuit Emphasis) parameters and model parameters provided by manufacturers of the passive component. Regarding a printed circuit board (PCB) model, which has not undergone testing to confirm agreement between measured and calculated values, it is essential to finely tune parasitic elements (ESR: electrical series resistance, ESL: electrical series inductance, etc.) for agreement between measured and calculated values. Transient analysis and fast Fourier transform (FFT: Fast Fourier Transform) are repeatedly executed to thereby reduce a difference between calculated and measured values. This state is the initial setting (Initialization).

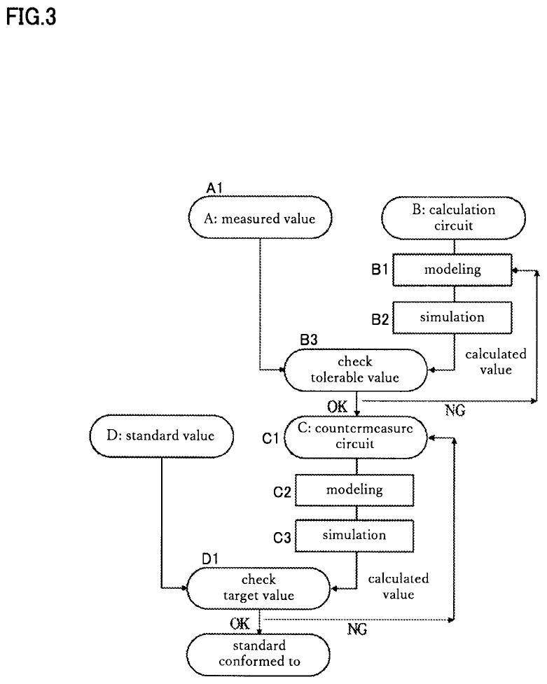

As a second stage, calculation is performed with respect to a circuit after the implementation of the electromagnetic compatibility (EMC) countermeasure. A countermeasure circuit is constituted of various components and parasitic elements selected from a group of circuits having been subjected to the above-described calculation verification. The verification is executed not on each individual component but on the circuit group as a whole, and thus the result is obtained macroscopically with approximate calculation accuracy. After repeatedly executed designing and calculation of the countermeasure circuit, conformity with an electromagnetic compatibility (EMC) standard is finally achieved. This state is the calculated prediction (Prediction) (see FIG. 3).

FIG. 3 is a flowchart until the achievement of conformity with the electromagnetic compatibility (EMC) standard.

### A1. Measured Value of Semiconductor Integrated Circuit (LSI)

Emission (EMI: Electromagnetic Interference, Emission) noise is measured, and the measured value is regarded as a true value.

### B1. Modeling of Calculation Circuit

A circuit, an element, etc. having been subjected to an electromagnetic compatibility (EMC)-standard compliance test are modeled. A current model for a semiconductor integrated circuit (LSI) is created from a calculated value or a measured value.

### B2. Simulation of Calculation Circuit

Transient analysis and fast Fourier transform (FFT) are executed under the conditions of B1 for transformation from a time domain to a frequency domain.

### B3. Checking Difference Between Measured Value and Calculated Value

Checking is performed to identify any difference between the measured value at A1 and the calculated value in B2. If any difference is identified, then it is estimated, based on its frequency characteristics, in which modeling the difference has occurred. After changing a constant and the like including a parasitic element, calculation and difference check are performed again. B1 to B3 are repeatedly performed until the difference falls within a tolerable value. When the difference falls within the tolerable value, the modeling of this time is fixed.

### C1. Consideration of Countermeasure Circuit

Consideration will be given to what kind of countermeasure circuit is the optimal countermeasure circuit to satisfy a target value (a standard value) from current characteristics.

### C2. Modeling of Countermeasure Circuit

The circuit of C1 is achieved using the model determined at B1. The circuit is described with a verified element of which a difference between a measured value and a calculated value is small, and thus it is possible to reduce <<an error>> of a predicted value (a calculated value).

### C3. Simulation of Countermeasure Circuit

Transient analysis and fast Fourier transform (FFT) are executed in the circuit of C2 for transformation of a time domain into a frequency domain.

D1. C1 to C3 are repeatedly performed until the difference between the target value and the calculated value satisfies the check target value (the standard value).

Note that there is a recognition that calculation in designing a semiconductor integrated circuit (LSI) and calculation in verifying electromagnetic compatibility (EMC) are significantly different from each other. As for the former, high-accuracy calculation within ±0.1 dB, for example, is required to obtain an amplification rate of a differential operational amplifier, and the like. On the other hand, the latter is for noise, and thus is acceptable as far as an obtained value is equal to or larger than, or equal to or smaller than, a specific limit value, and a calculation difference of 6 dB, for example, may cause no problem except in the vicinity of the limit value (unless compliance/non-compliance judgment is reversed). Thus, calculation errors need to be handled with understanding of their characteristics.

### <Computer Model Based on Measured Value (Emission Calculation Verification)>

In circuit calculation of a semiconductor integrated circuit (LSI), SPICE parameters and model parameters of semiconductor elements (transistors) and passive elements (resistive elements, capacitive elements, etc.) are inputted, and electrical characteristics of a circuit diagram described by a designer of a semiconductor integrated circuit (LSI) designer are calculated. Today, unlike a decade ago, there is a remarkable progress in compact models, and calculation results substantially agree with results obtained by measurement with an actually fabricated prototype semiconductor integrated circuit (LSI).

In this case, it appears that electrical characteristics are predicted from only calculated values so as to agree with measured values, but in fact SPICE parameters and model parameters of a semiconductor device (a transistor) inputted into a computer are extracted from measured values. Parameters are extracted so as to agree with current characteristics (IV curve) and capacitance characteristics (CV curve) of a semiconductor device (a transistor) measured from TEG (Test Element Gear, a silicon piece (silicon chip)) for characteristics evaluation. Thus, in circuit calculation for a semiconductor integrated circuit (LSI) as well, a computer model where measured values are taken into consideration (hereinafter referred to as a computer model based on measured values, DPS: Difference Predictive Simulation Model) is used.

In electromagnetic compatibility (EMC) verification as well, application of the same method is tested and proposed. A computer model is extracted while taking a measured value into consideration. For that purpose, as a basic premise in calculated prediction of electromagnetic compatibility (EMC) verification, a measured value is treated as a true value to set a reference for a calculated value. In calculated prediction that is based solely on a calculated value, a difference may occur with respect to a measured value.

To deal with a difference between a calculated value and a measured value, consideration is given to using a difference correction value (DCV: Difference Corrected Value) to include all uncertain elements therein. Detailed examinations of components of electronic and electrical products show that computer models of active components such as a semiconductor integrated circuit (LSI) including a resin sealed product (a package) and the like, as well as passive components such as a resistor, a capacitor, an inductor, and the like are created based on measured values.

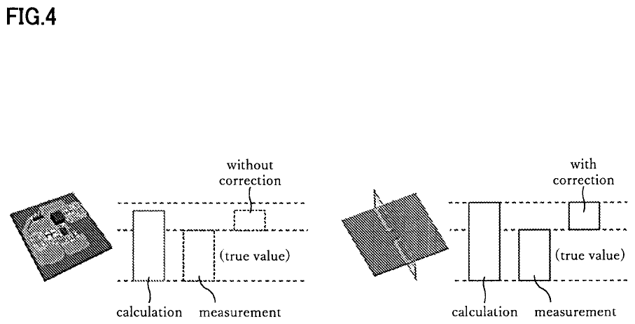

However, it seems that examples are rare in which a printed circuit board (PCB) computer model is created based on measured values. There is a great likelihood that it is in a printed circuit board (PCB) that a computer model based on measured values (DPS) is not used. Thus, consideration will now be given to calculation verification that is made simple and convenient by including influence of parasitic elements of a printed circuit board (PCB) and the like in a difference correction value, and further by replacing to a simple-shaped circuit board and including a difference due to the replacement in the difference correction value (DCV) (see FIG. 4).

FIG. 4 is a diagram illustrating a concept of the computer model based on measured values (DPS).

In common electromagnetic field analysis (Electromagnetic Analysis), it is necessary to collect information as detailed as possible regarding a semiconductor integrated circuit (LSI), a printed circuit board (PCB), and a mounted component. In contrast, in electromagnetic compatibility (EMC) verification, reversely, attempts are made to determine to what extent information can be reduced while still allowing for simple and accurate verification. A very advantageous situation can be achieved by introducing a measured value as a true value and a difference correction value (DCV) obtained from the measured value. Specifically, expectations are put for advantages of a simplified process of creating computer models, securing high accuracy of calculation, drastically reducing calculation times, reducing large investment in building calculation environment, etc.

These targets are the same as those of linear model analysis (SLS: Super Linear Solver), reduced order model analysis (MOR: Model Order Reduction), etc. for electromagnetic field analysis (Electromagnetic Analysis) with high speed.

Reference will be made to a computer model based on measured values (DPS) in electromagnetic compatibility (EMC) verification. It is applied to calculation verification of conducted emission (CE: Conducted Emission) and radiated emission (RE: Radiated Emission).

In initial setting (Initialization) of a first stage, when expressed by an expression, the previously mentioned difference correction value (DCV) can be described by an extremely simple expression (see expression (1)).

$$DELTA 0 = SIM 0 - MSR 0 \qquad ( 1 )$$

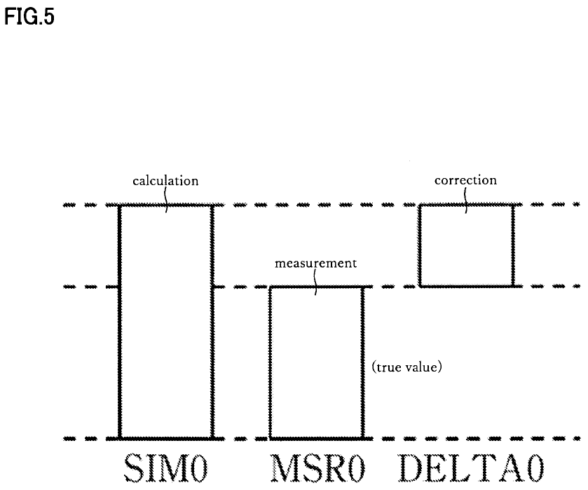

In expression (1), DELTA0 represents a difference correction value (DCV), SIM0 represents a calculated value before implementation of an electromagnetic compatibility (EMC) countermeasure, and MSR0 represents a measured value before the implementation of the electromagnetic compatibility (EMC) countermeasure. It is important to calculate this difference correction value (DCV) DELTA0 (see FIG. 5).

FIG. 5 is a diagram illustrating the calculation of the difference correction value (DCV) DELTA0.

When the difference corrected value (DCV) DELTA0 is obtained, then it is possible, by subtracting DELTA0 from the calculated value SIM0 before the implementation of the electromagnetic compatibility (EMC) countermeasure, to obtain the measured value MSR0 before the implementation of the electromagnetic compatibility (EMC) countermeasure as a calculated prediction value OPT (see expression (2)).

$$\begin{matrix}OPT = SIM 0 - DELTA 0 \\ = SIM 0 - ( SIM 0 - MSR 0 ) \\ = MSR 0\end{matrix} \qquad ( 2 )$$

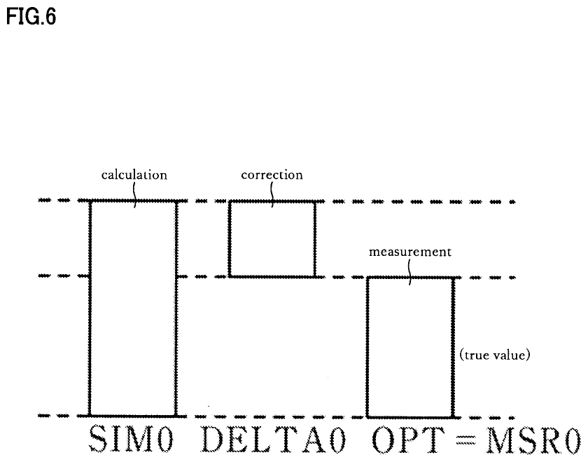

Here, OPT (optimization: Optimization) represents a calculated value before the implementation of the electromagnetic compatibility (EMC) countermeasure in which the measured value is taken into consideration. Again, by performing difference calculation, the calculated prediction value OPT before the implementation of the electromagnetic compatibility (EMC) countermeasure agrees with the measured value MSR0 before the implementation of the electromagnetic compatibility (EMC) countermeasure (see FIG. 6).

FIG. 6 is a diagram illustrating a calculation concept of Optimization.

In calculated prediction (Prediction) of a second stage, from the calculated value SIM after the implementation of the electromagnetic compatibility (EMC) countermeasure, the difference correction value (DCV) DELTA0 is subtracted as in the first stage (see expression (3)).

$$\begin{matrix}PREDIC = SIM - DELTA 0 \\ = SIM - ( SIM 0 - MSR 0 ) \\ = MSR 0 - ( SIM 0 - SIM )\end{matrix} \qquad ( 3 )$$

Here, PREDIC (calculated prediction: Prediction) represents a calculated prediction value after the implementation of the electromagnetic compatibility (EMC) countermeasure in which the measured value is taken into consideration, and SIM represents a calculated value after the implementation of the electromagnetic compatibility (EMC) countermeasure. By performing the difference calculation, the calculated prediction value PREDIC after the implementation of the electromagnetic compatibility (EMC) countermeasure becomes equal to a value obtained by subtracting an effect (SIM0−SIM) of an electromagnetic compatibility (EMC) countermeasure circuit from the measured value (the true value) MSR0.

Influence of parts where no change is observed before and after the implementation of the electromagnetic compatibility (EMC) countermeasure, such as a semiconductor integrated circuit (LSI), a resin sealed product (a package), a printed circuit board (PCB), passive elements excluding a countermeasure circuit, etc., are all offset (canceled) and thus have no influence on the calculated prediction, and thus a minimum calculation error is obtained.

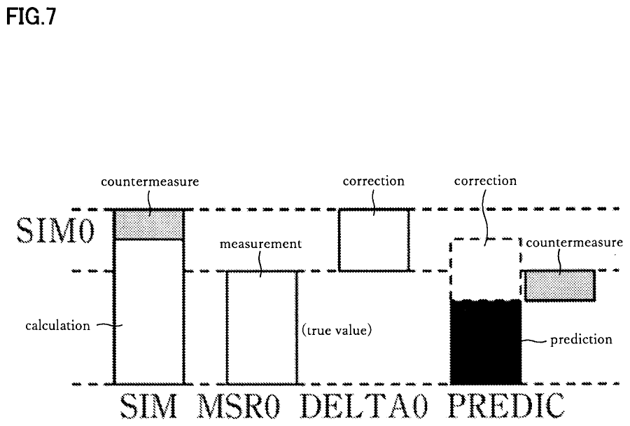

It can be inferred that the circuit where the calculation error occurs is solely the part of the effect of the countermeasure circuit (SIM0−SIM). In expression (3), physical interpretation of what is indicated by the difference calculation between second and third terms thereof is more important than the calculated value itself (see FIG. 7).

FIG. 7 is a diagram illustrating a calculation concept of the calculated prediction (Prediction).

In a case where 0 (zero) is inputted as the measured value MSR0, attenuation characteristics of the electromagnetic compatibility (EMC) countermeasure circuit is obtained as the calculated prediction value (see expression (4)).

$$\begin{matrix}PREDIC = MSR 0 - ( SIM 0 - SIM ) \\ = SIM - SIM 0\end{matrix} \qquad ( 4 )$$

The above calculation process is very similar to the process of “resistance trimming” in an analog semiconductor integrated circuit (LSI) design. It is a difference calculation method (prediction by difference calculation) that results in a large difference if performed with an absolute value (prediction solely with a calculated value), but that provides a result surprisingly close to the correct answer if performed with a relative value. Generally, it can be said that a calculation method where a solution can be obtained through a single calculation is the absolute value calculation, and that a calculation method where a solution can be obtained through two or more calculations is a relative value calculation (a difference calculation method). As a supplementary note, in designing an analog semiconductor integrated circuit (LSI), circuit design (absolute value design) is discouraged in which characteristics are determined by absolute values of elements, and thus circuits are designed such that characteristics are all determined by relative values among elements (relative value design). This is for the purpose of addressing variation among elements in a semiconductor integrated circuit (LSI).

<Computer Model based on Measured Values (Immunity Calculation Verification)>

In a case of calculation verification of conducted immunity (CI: Conducted Immunity) and radiated immunity (RI: Radiated Immunity), what corresponds to the computer model based on measured values (DPS) is a malfunction threshold (IB: Immunity Behavior) model.

In the DPI (Direct RF Power Injection) method in the IEC 62132-4 standard, in actual measurement, a dual-directional coupler is connected to a power amplifier, and power W is fed via a capacitor C to a power supply terminal and the like. Forward-wave power Wf when a semiconductor integrated circuit (LSI) as a measurement-target circuit DUT (Device Under Test) malfunctions is recorded as the measured value at that time.

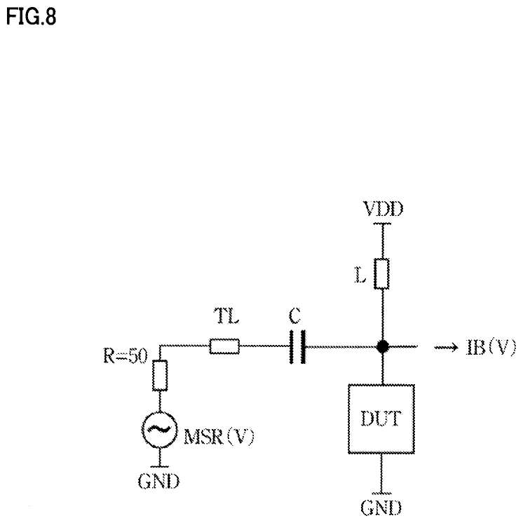

As the initial setting (Initialization) of the first stage, a circuit diagram equivalent to a measurement system is first created, and a value obtained by converting the measured value (the forward-wave power Wf) into a voltage Vf and a current If for a resistance of 50Ω (in the case of voltage, MSR(V)) is applied to a calculation circuit. Here, R represents a signal source resistance, and TL represents a transmission line. A voltage V and a current I at the power supply terminal of a calculation-target circuit DUT obtained by circuit analysis become the malfunction threshold (IB) model (see FIG. 8).

FIG. 8 is a diagram illustrating a calculation concept of the malfunction threshold (IB) model.

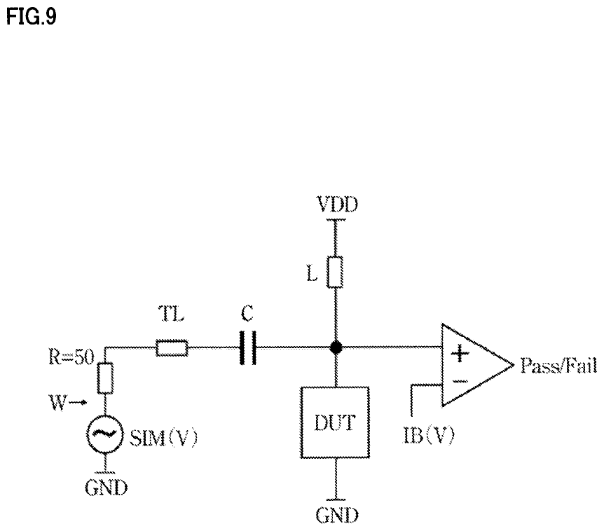

Next, the measured value (the forward-wave power Wf) before the implementation of the electromagnetic compatibility (EMC) countermeasure is obtained by calculation verification in the following manner: circuit analysis is performed with, as input sources, sine-wave signals SIM (V) and SIM (I) in which an attenuation coefficient THETA is effective, and by obtaining the value of power (W in the figure) when the calculation-target circuit DUT malfunctions, the measured value (the forward-wave power Wf) can be reproduced. Here, a differential operational amplifier refers to a virtual computing unit that performs comparison and determination on magnitudes of the malfunction threshold IB (V) and noise transmitted to the calculation-target circuit DUT (see FIG. 9).

FIG. 9 is a diagram illustrating a calculation concept of the initial setting (Initialization).

Note that, although the power W cannot be treated directly in circuit analysis, it is possible to calculate the power W from the voltage V and the current I using macro language descriptions and script language descriptions.

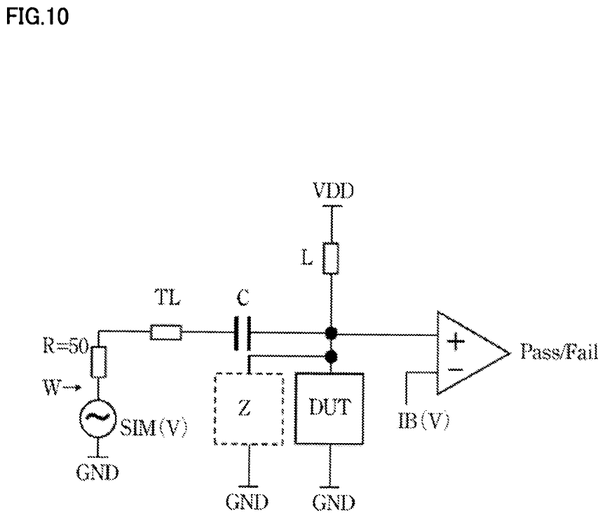

In the calculated prediction (Prediction) of the second stage, in order to obtain the calculated prediction value after the implementation of the electromagnetic compatibility (EMC) countermeasure, an impedance Z is connected to a ground terminal GND to thereby set an avoidance route or a composite impedance Z with the calculation-target circuit DUT is reduced such that the sine wave signals SIM (V) and SIM (I) in which the attenuation coefficient THETA is made effective is prevented from being transmitted directly to the calculation-target circuit DUT. By optimally setting the impedance Z, improvement can be expected in malfunction resistance of the DPI method of the IEC 62132-4 standard (see FIG. 10).

FIG. 10 is a diagram illustrating a calculation concept of the calculated prediction (Prediction).

Effectiveness of both the emission calculation verification and the immunity calculation verification can be confirmed in practical applications as well. In executing an electromagnetic compatibility (EMC) countermeasure at a measurement site, there can be a case where a passive component is attached and detached frequently. By considering optimization of the electromagnetic compatibility (EMC) countermeasure circuit in advance, the effectiveness is also confirmed in reducing operation time at the measurement site.

Here, using measured values instead of calculated values tends to be judged inapplicable to the circuit designing stage of an ESI (First Engineering Sample, a first cut sample), which is a semiconductor integrated circuit (LSI) of first prototype. However, regarding semiconductor integrated circuits (LSI), a surprisingly large number of similar types and additional functions have been developed, and a surprisingly small number of designs have been developed based on completely new principles and new circuit designs. In this situation, by using measured values of similar types, a computer model can be created and applied.

Further, it is also determined, based on circuit configurations and circuit constants, etc. of passive components and active components of the countermeasure circuit, whether various electromagnetic compatibility (EMC) countermeasure are each to be executed on a printed circuit board (PCB) or inside a semiconductor integrated circuit (LSI). In electromagnetic compatibility (EMC) design, neither countermeasures executed on a printed circuit board (PCB) alone nor countermeasures executed inside semiconductor integrated circuits (LSI) alone can exert a sufficient effect, but if they work together in a circuit design, they can produce a synergy effect.

Thus, there will now be described, by phenomenon, electromagnetic compatibility (EMC) verification examples for representative semiconductor integrated circuits (LSI) to which these are applied.

### <Conducted Emission (CE)) Calculation Verification>

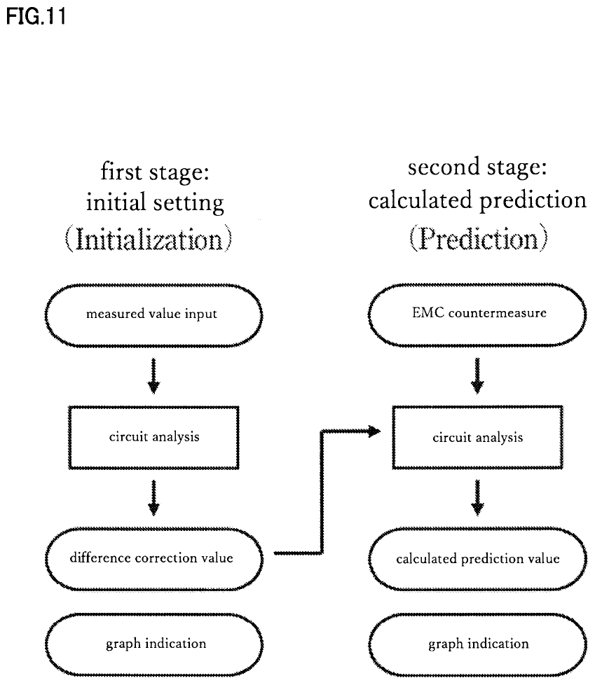

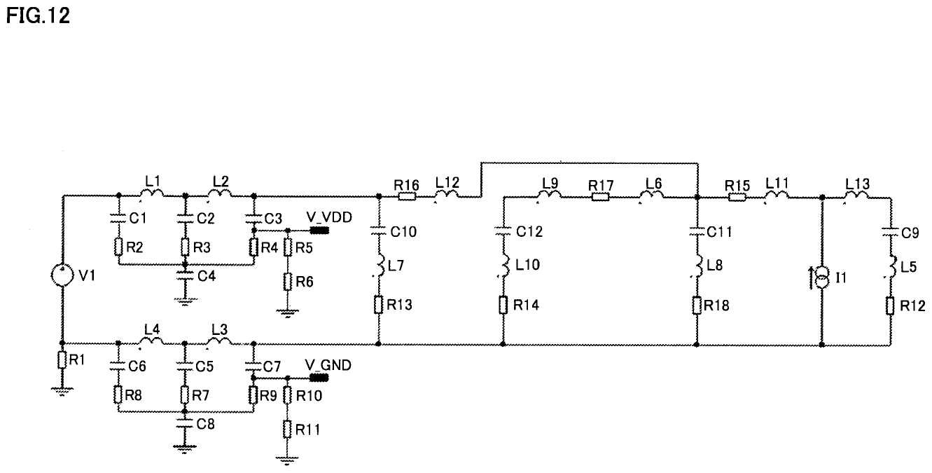

Here, as an example of electromagnetic compatibility (EMC) verification, a case of a common intermittent (switching) power supply will be described. It is a step-down power supply of which an output voltage smaller than an input voltage, and of which an output current is 3 A (ampere). Conducted emission (CE) characteristics before and after implementation of an electromagnetic compatibility (EMC) countermeasure are judged on conformity with the CISPR32 standard, noise terminal voltage, Class B requirements. Verification frequencies include a fundamental frequency of an intermittent (switching) frequency and its harmonics, and are up to 30 MHz (or 100 MHz). Using a calculation verification algorithm that conforms to the IEC 62433-2 standard, circuit analysis (transient analysis) is performed one time using script language descriptions, to be completed in about two minutes (see FIG. 11 and FIG. 12).

FIG. 11 is a flowchart of calculation verification of conducted emission (CE). FIG. 12 is a verification circuit diagram for circuit analysis of conducted emission (CE).

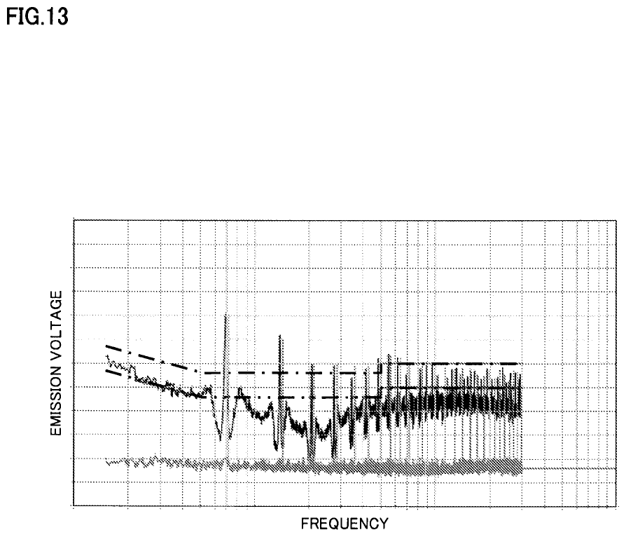

In the initial setting (Initialization) of the first stage, from a measured value and a calculated value before the implementation of the electromagnetic compatibility (EMC) countermeasure, their difference collection/corrected value (DCV) is obtained. In the calculated prediction (Prediction) of the second stage, calculated prediction of characteristics after the implementation of the electromagnetic compatibility (EMC) countermeasure is performed while taking the difference correction value (DCV) into consideration. By using a computer model (DPS) based on measured values, measured values and calculated values before the implementation of the electromagnetic compatibility (EMC) countermeasure are indicated (see FIG. 13).

FIG. 13 is a diagram illustrating an example of initial setting of conducted emission (CE) (the intermittent (switching) power supply_before the implementation of the electromagnetic compatibility (EMC) countermeasure). In the present figure, a horizontal axis represents frequency, and a vertical axis represents intensity of conducted emission. Further, a black line represents measured values, and a gray line represents calculated values. Further, a dashed-and-dotted line and a dashed-and-double-dotted line respectively represent electromagnetic compatibility (EMC) standard limit values.

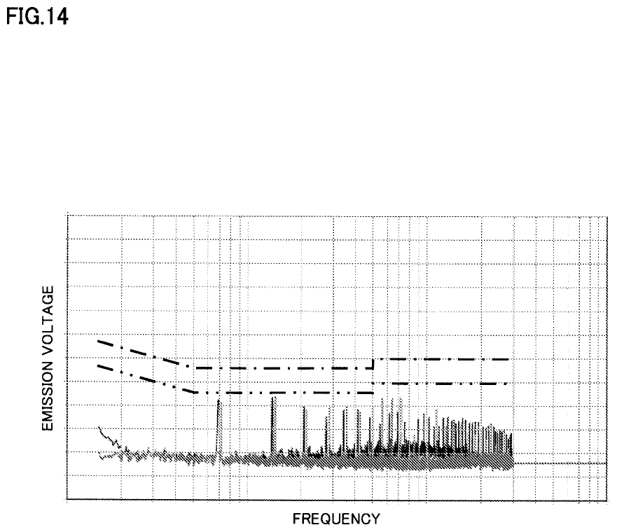

Calculated values of the fundamental frequency of the intermittent (switching) power supply and its harmonics substantially agree with their measured values. It is due to partial oscillation of a semiconductor integrated circuit that the measured values include large floor noise (floor noise). As the floor noise in the calculated values, no-signal floor noise in the measured values is indicated. On the other hand, measured values and calculated values after the implementation of the electromagnetic compatibility (EMC) countermeasure are indicated (see FIG. 14).

FIG. 14 is a diagram illustrating an example of calculated prediction of conducted emission (CE) (the intermittent (switching) power supply_after the implementation of the electromagnetic compatibility (EMC) countermeasure). A horizontal axis of the present figure represents frequency, and a vertical axis of the present figure represents intensity of conducted emission. Further, a black line represents measured values, and a gray line represents calculated values. Further, the dashed-and-dotted line and the dashed-and-double-dotted line respectively represent electromagnetic compatibility (EMC) standard limit values.

Likewise, calculated values of the fundamental frequency of the intermittent (switching) frequency and its harmonics show tendency of good agreement with their measured values, and a result is obtained that conforms to the CISPR32 standard, noise terminal voltage, Class B requirements. In addition, the IEC 61967-4 (1Ω method/150Ω method) standard, the CISPR25 standard voltage method/current probe method, electromagnetic (EMC) compatibility characteristics evaluation of a single semiconductor integrated circuit (LSI), etc. are also dealt with.

### <Radiated Emission (RE) Calculation Verification>

Here, also, as an example of electromagnetic compatibility (EMC) verification, a case of a common intermittent (switching) power supply will be described. It is a step-down power supply of which an output voltage is smaller than an input voltage, and of which an output current is 3 A (ampere). Radiated emission (RE: Radiated Emission) characteristics before and after implementation of an electromagnetic compatibility (EMC) countermeasure are judged on conformity with the CISPR32 standard, the 3-meter method, Class A and Class B requirements. Verification frequencies include a fundamental frequency of an intermittent (switching) frequency and its harmonics, and 100 frequencies are set.

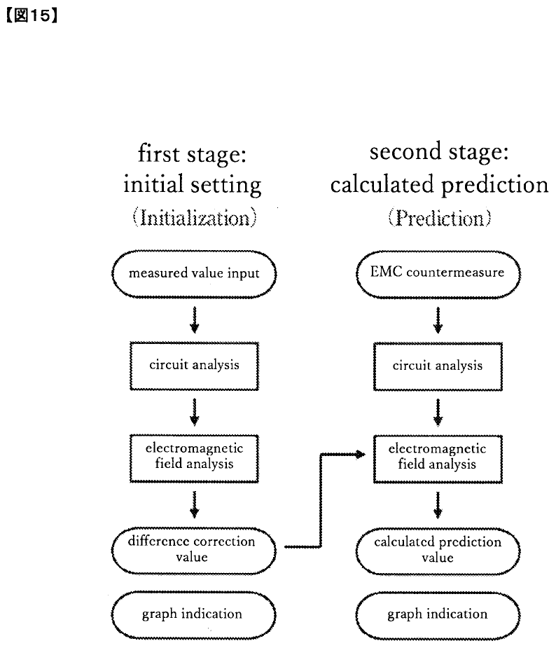

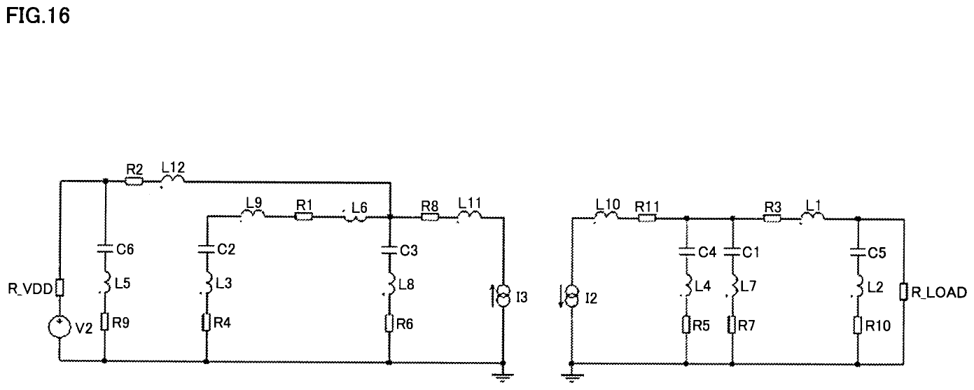

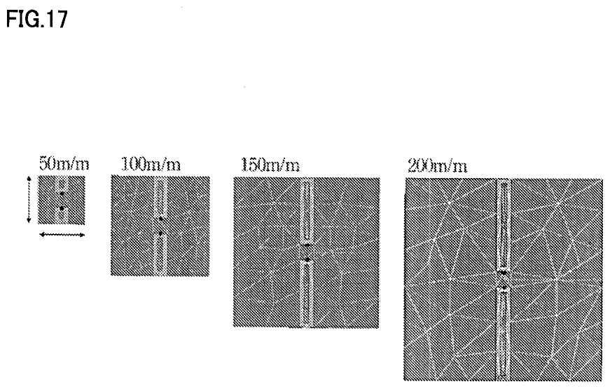

Using a calculation verification algorithm that is a derivative of the IEC 62433-2 standard, circuit analysis (transient analysis) is performed one time originally and electromagnetic field analysis ((MoM: Method of Moment, the moment method) is performed 100 times using script language descriptions, to be completed in about 10 minutes (see FIG. 15, FIG. 16 and FIG. 17).

FIG. 15 is a flowchart of calculation verification of radiated emission (RE). FIG. 16 is a verification circuit diagram for circuit analysis of radiated emission (RE). FIG. 17 is a verification circuit board diagram for electromagnetic field analysis of radiated emission (RE).

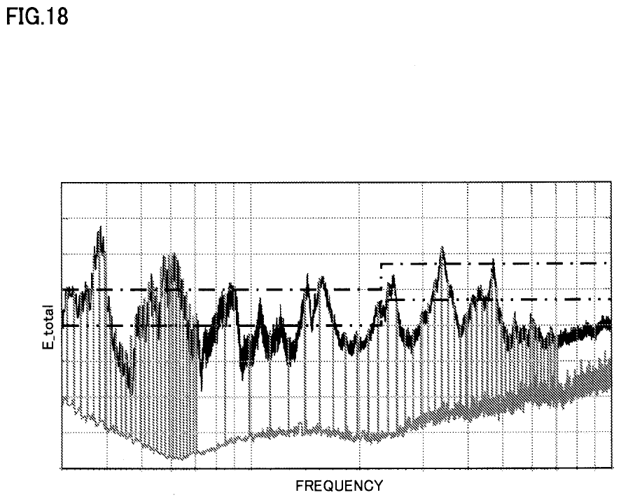

In the initial setting (Initialization) of the first stage, from a measured value and a calculated value before the implementation of the electromagnetic compatibility (EMC) countermeasure, their difference correction value (DCV) is obtained. In the calculated prediction (Prediction) of the second stage, calculated prediction of characteristics after the implementation of the electromagnetic compatibility (EMC) countermeasure is performed while taking the difference correction value (DCV) into consideration. By using a computer model (DPS) based on measured values, the measured values and the calculated values before the implementation of the electromagnetic compatibility (EMC) countermeasure are indicated (see FIG. 18).

FIG. 18 is a diagram illustrating an example of initial setting of radiated emission (RE) (the intermittent (switching) power supply_before the implementation of the electromagnetic compatibility (EMC) countermeasure). In the present figure, a horizontal axis represents frequency, and a vertical axis represents intensity of radiated emission. Further, a black line represents measured values, and a gray line represents calculated values. Further, a dashed-and-dotted line and a dashed-and-double-dotted line respectively represent electromagnetic compatibility (EMC) standard limit values.

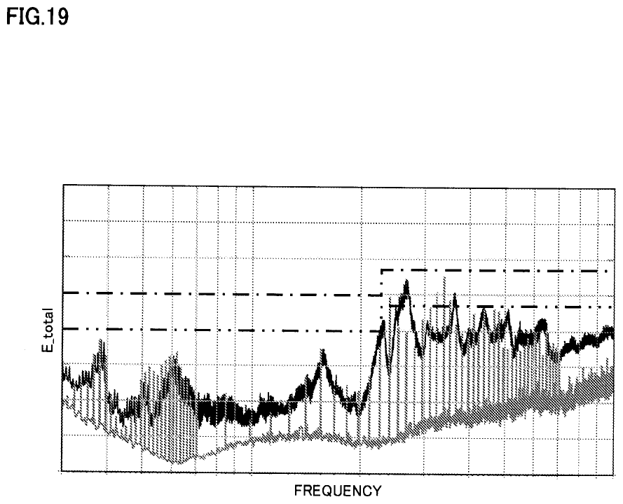

Calculated values of the fundamental frequency of the intermittent (switching) frequency and its harmonics substantially agree with their measured values. As the floor noise in the calculated values, no-signal floor noise in the measured values is indicated. On the other hand, measured values and calculated values after the implementation of the electromagnetic compatibility (EMC) countermeasure are indicated (see FIG. 19).

FIG. 19 is a diagram illustrating an example of calculated prediction of radiated emission (RE) (the intermittent (switching) power supply_after the implementation of the electromagnetic compatibility (EMC) countermeasure). In the present figure, a horizontal axis represents frequency, and a vertical axis represents intensity of radiated emission. Further, a black line represents measured values, and a gray line represents calculated values. Further, a dashed-and-dotted line and a dashed-and-double-dotted line respectively represent electromagnetic compatibility (EMC) standard limit values.

Likewise, calculated values of the fundamental frequency of the intermittent (switching) frequency and its harmonics show tendency of substantially good agreement with their measured values, but in this state, a result is obtained that is not in conformity with the CISPR32 standard, the 3-meter method, Class B requirements (but is in conformity with the Class A requirements). In addition, the CISPR32 standard 10-method is also dealt with. Here, division spline function approximation of graphing software is used for envelope-line (envelope) processing of intermediate value processing. Here, the frequency band division number is 3, but by increasing the number to about 10, for example, calculation accuracy is further improved. Further, a far-field electric field value E is a composite value of a root mean square of a horizontal component EH and a vertical component EV, of which each can also be indicated (see expression (5)).

$$√ ( EH \cdot EH + EV \cdot EV ) \qquad ( 5 )$$

### <Conducted Immunity (CI) Calculation Verification>

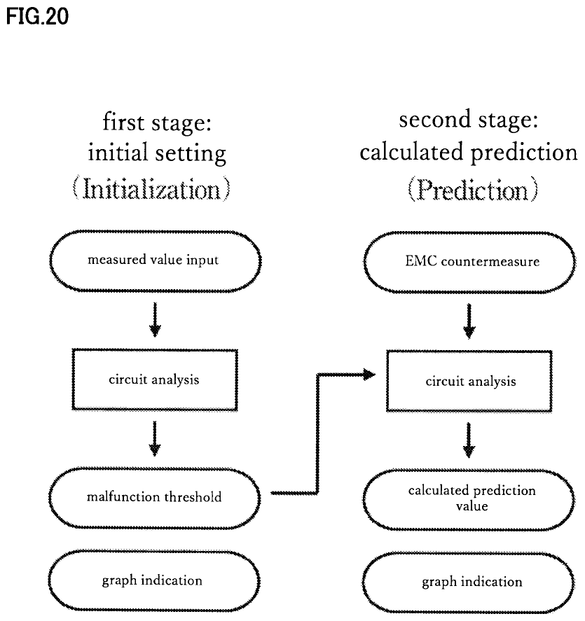

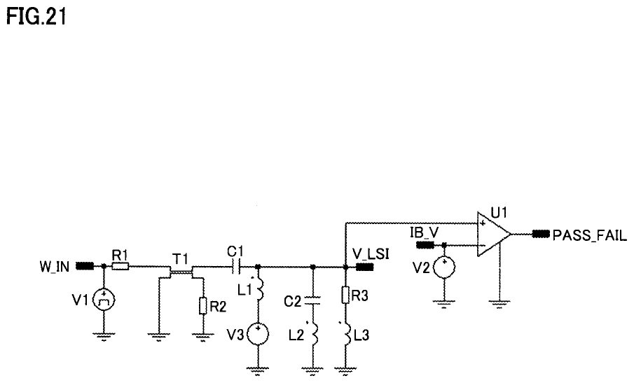

Here, as an example of electromagnetic compatibility (EMC) verification, a case of a common microcomputer will be described. Conducted immunity (CI) characteristics before and after implementation of an electromagnetic compatibility (EMC) countermeasure are judged on conformity with the IEC 62132-4 standard DPI (Direct RF Power Injection) method (the BISS standard Global Pin•Local Pin requirements). Verification frequencies include 278 frequencies as stipulated by the standard. Using a calculation verification algorithm based on the IEC 62433-4 standard, circuit analysis (transient analysis) is performed 278 times using script language descriptions, to be completed in about 10 minutes (see FIG. 20 and FIG. 21).

FIG. 20 is a flowchart of calculation verification of conducted immunity (CI). FIG. 21 is a verification circuit diagram for circuit analysis of conducted immunity (CI).

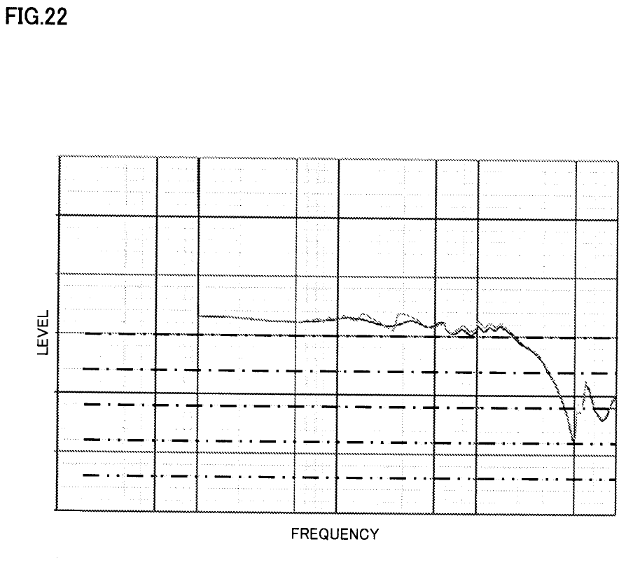

In the initial setting (Initialization) of the first stage, from measured values before the implementation of the electromagnetic compatibility (EMC) countermeasure, a malfunction threshold (IB) model is extracted. In the calculated prediction (Prediction) of the second stage, calculated prediction of characteristics after the implementation of the electromagnetic compatibility (EMC) countermeasure is performed while taking the malfunction threshold (IB) model into consideration. Measured values and calculated values before the implementation of the electromagnetic compatibility (EMC) countermeasure are indicated (see FIG. 22).

FIG. 22 is a diagram illustrating an example of initial setting of conducted immunity (CI) (the microcomputer, before the implementation of the electromagnetic compatibility (EMC) countermeasure). In the present figure, a horizontal axis represents frequency, and a vertical axis represents malfunction level of conducted immunity. Further, a black line represents measured values, and a gray line represents calculated values. Further, a dashed-and-dotted line and a dashed-and-double-dotted line respectively represent electromagnetic compatibility (EMC) standard limit values.

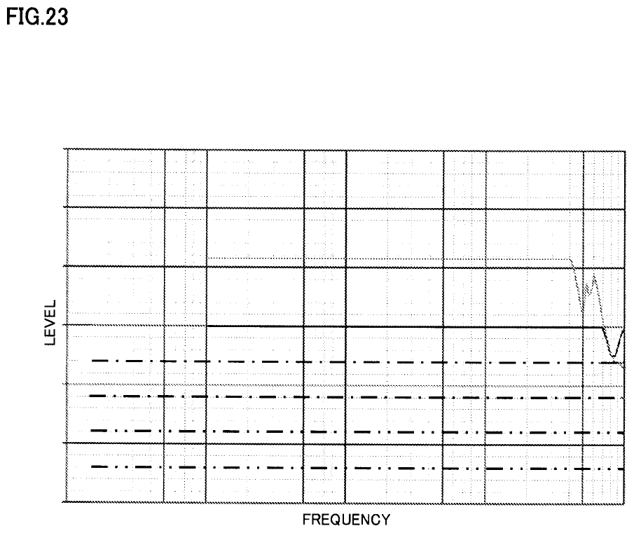

A calculated value of the forward-wave power Wf that causes a malfunction substantially agrees with its measured value. On the other hand, measured values and calculated values after the implementation of the electromagnetic compatibility (EMC) countermeasure are indicated (see FIG. 23).

FIG. 23 is a diagram illustrating an example of calculated prediction of conducted immunity (CI) (the microcomputer, after the implementation of the electromagnetic compatibility (EMC) countermeasure). In the present figure, a horizontal axis represents frequency, and a vertical axis represents malfunction level of conducted immunity. Further, a black line represents measured values, and a gray line represents calculated values. Further, a dashed-and-dotted line and a dashed-and-double-dotted line respectively represent electromagnetic compatibility (EMC) standard limit values.

A calculated value of the forward-wave power Wf that similarly causes a malfunction shows tendency of good agreement with its measured value in a high frequency range, and in this state, a result is obtained that is in conformity with the IEC 62132-4 standard the DPI method (the Local Pin requirements of the BISS standard). In a low frequency range, calculated prediction values equal to or larger than a limit value are obtained, and thus it is determined that the standard is conformed to.

### <Radiated Immunity (RI) Calculation Verification>

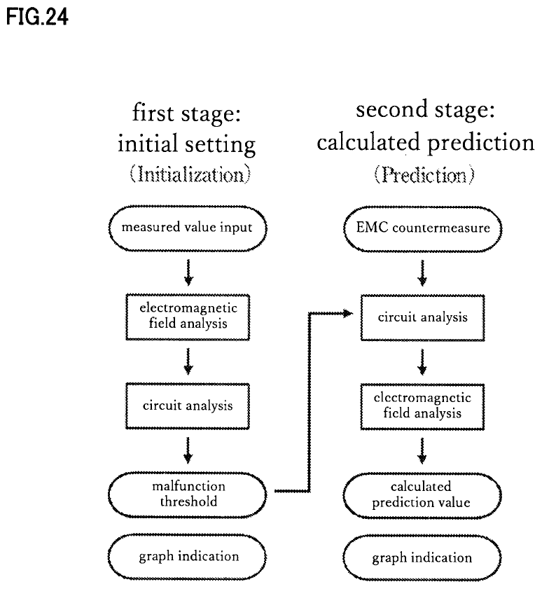

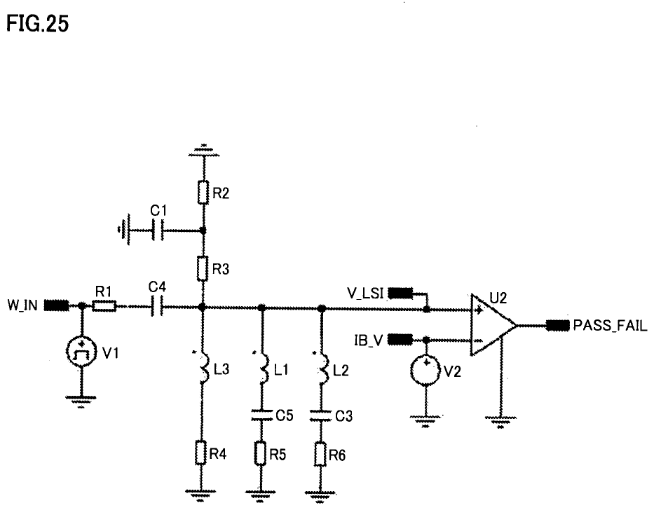

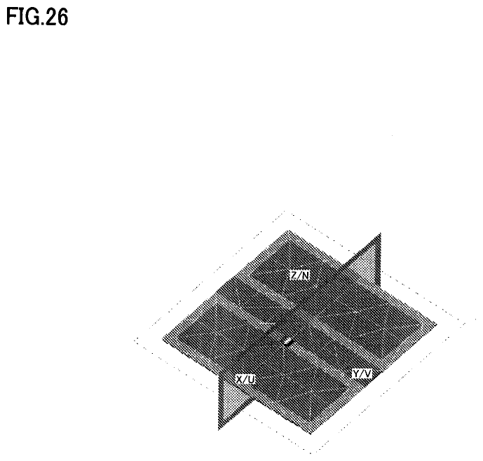

Here, as an example of electromagnetic compatibility (EMC) verification, a case of a common differential operational amplifier will be described. Radiated immunity (RI) characteristics before and after implementation of an electromagnetic compatibility (EMC) countermeasure are judged on conformity with the IEC 61000 April 3 standard. Verification frequencies include any 65 frequencies. A calculation verification algorithm that is not established as the IEC 62433-5 standard and thus is a derivative of the IEC 62433-4 standard is used, circuit analysis (transient analysis) is performed 260 times originally, and electromagnetic field analysis (MoM: Method of Moment) is performed 130 times using script language description, to be completed in about 15 minutes (see FIG. 24, FIG. 25 and FIG. 26).

FIG. 24 is a flowchart of calculation verification of radiated immunity (RI). FIG. 25 is a verification circuit diagram for circuit analysis of radiated immunity (RI). FIG. 26 is a verification circuit board diagram for electromagnetic field analysis of radiated immunity (RI).

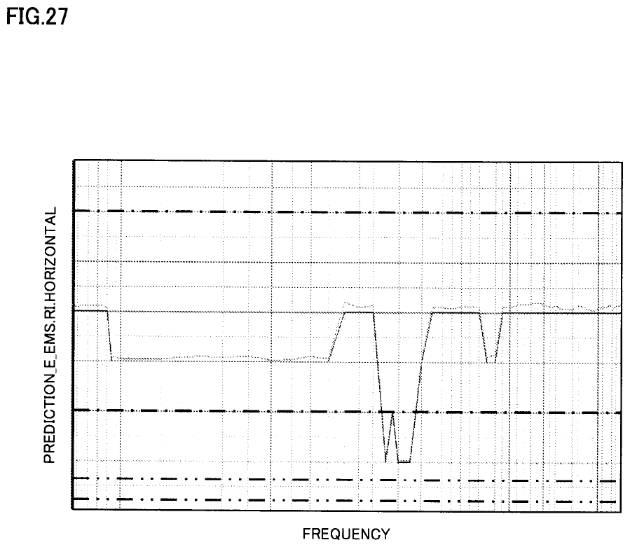

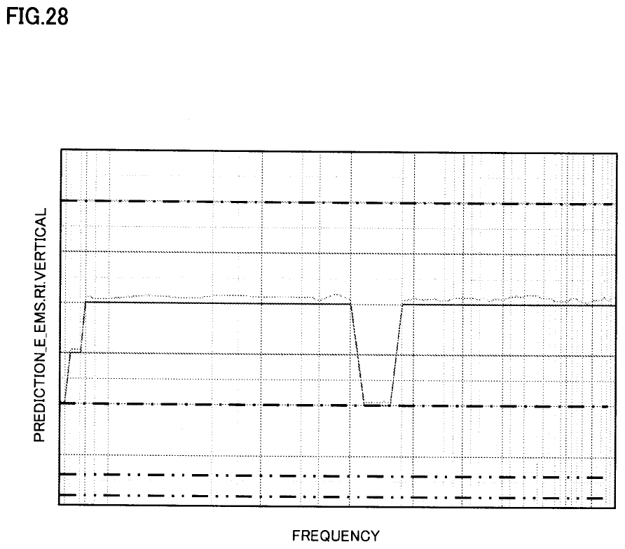

In the initial setting (Initialization) of the first stage, from measured values before the implementation of the electromagnetic compatibility (EMC) countermeasure, a malfunction threshold (IB) model is extracted. In the calculated prediction (Prediction) of the second stage, calculated prediction of characteristics after the implementation of the electromagnetic compatibility (EMC) countermeasure is performed while taking the malfunction threshold (IB) model into consideration. Measured values and calculated values before the implementation of the electromagnetic compatibility (EMC) countermeasure are indicated (see FIG. 27, FIG. 28).

FIG. 27 is a diagram illustrating a first example of initial setting of radiated immunity (RI) (the differential operational amplifier, before the implementation of the electromagnetic compatibility (EMC) countermeasure, horizontal). In the present figure, a horizontal axis represents frequency, and a vertical axis represents malfunction level of radiated immunity. Further, a black line represents measured values, and a gray line represents calculated values. Further, a dashed-and-dotted line and a dashed-and-double-dotted line respectively represent electromagnetic compatibility (EMC) standard limit values.

FIG. 28 is a diagram illustrating a second example of initial setting of radiated immunity (RI) (the differential operational amplifier, before the implementation of the electromagnetic compatibility (EMC) countermeasure, vertical). In the present figure, a horizontal axis represents frequency, and a vertical axis represents malfunction level of radiated immunity. Further, a black line represents measured values, and a gray line represents calculated values. Further, a dashed-and-dotted line and a dashed-and-double-dotted line respectively represent electromagnetic compatibility (EMC) standard limit values.

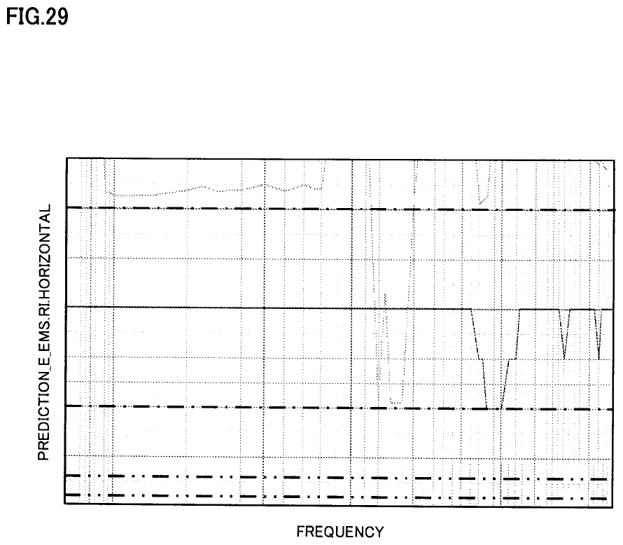

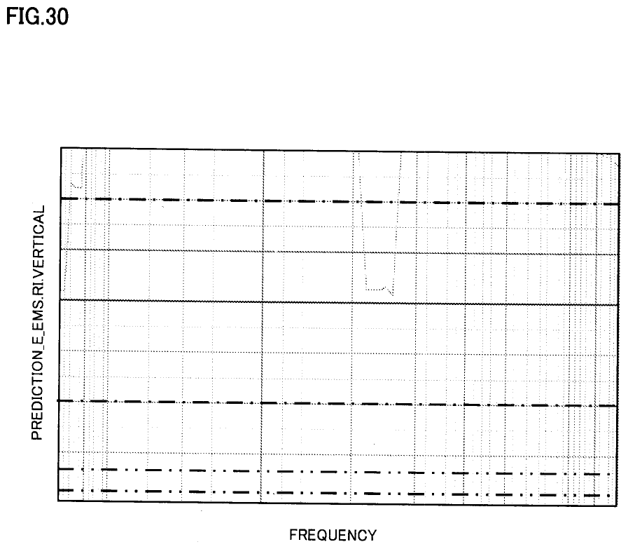

A calculated value of an electric field that causes malfunction substantially agrees with its measured value. On the other hand, measured values and calculated values after the implementation of the electromagnetic compatibility (EMC) countermeasure are indicated (see FIG. 29, FIG. 30).

FIG. 29 is a diagram illustrating a first example of calculated prediction of radiated immunity (RI) (the differential operational amplifier, before the implementation of the electromagnetic compatibility (EMC) countermeasure, horizontal). In the present figure, a horizontal axis represents frequency, and a vertical axis represents malfunction level of radiated immunity. Further, a black line represents measured values, and a gray line represents calculated values. Further, a dashed-and-dotted line and a dashed-and-double-dotted line respectively represent electromagnetic compatibility (EMC) standard limit values.

FIG. 30 is a diagram illustrating a second example of calculated prediction of radiated immunity (RI) (the differential operational amplifier, before the implementation of the electromagnetic compatibility (EMC) countermeasure, vertical). In the present figure, a horizontal axis represents frequency, and a vertical axis represents malfunction level of radiated immunity. Further, a black line represents measured values, and a gray line represents calculated values. Further, a dashed-and-dotted line and a dashed-and-double-dotted line respectively represent electromagnetic compatibility (EMC) standard limit values.

Comparison between calculated values of electric fields that cause malfunction and their measured values here does not show agreement between the calculated and measured values in the direction of the frequency axis (it is determined from measurement results that a calculated value corresponding to an electric field intensity of 20 V/m of higher does not cause malfunction).

In cases where the electromagnetic compatibility (EMC) countermeasure causes shift of resonance frequency and anti-resonance frequency, for example, an extra countermeasure needs to be provided. As a supplementary note, since the IEC 61000 April 3 standard measurement is for conformity judgment with respect to various electric-field values, basically malfunction intensity cannot be illustrated. To cope with this, testing electric-field intensities are tested with discrete values from low electric field intensity to high electric field intensity to thereby obtain the malfunction threshold (IB) in a pseudo manner.

In the above manner, electromagnetic compatibility (EMC) verification was tested on a phenomenon-by-phenomenon basis with respect to a semiconductor integrated circuit (LSI). There still is much room for improvement in calculation accuracy, calculation speed, calculation preparation, etc. However, comparing the situation where effects of countermeasure circuits for electromagnetic compatibility (EMC) cannot be predicted by calculation at all and the situation where, even though approximately, effects of countermeasure circuits for electromagnetic compatibility (EMC) can be detected by calculation, it can be said that there is a world of difference between these two situations. Further, by developing various calculation verification in advance, even calculation verification for a different standard can be dealt with quickly and comparatively easily by changing circuit diagrams and so on.

### <Evaluation Method for Semiconductor Device Integrated Circuit (Introduction of Noise Elimination Step)>

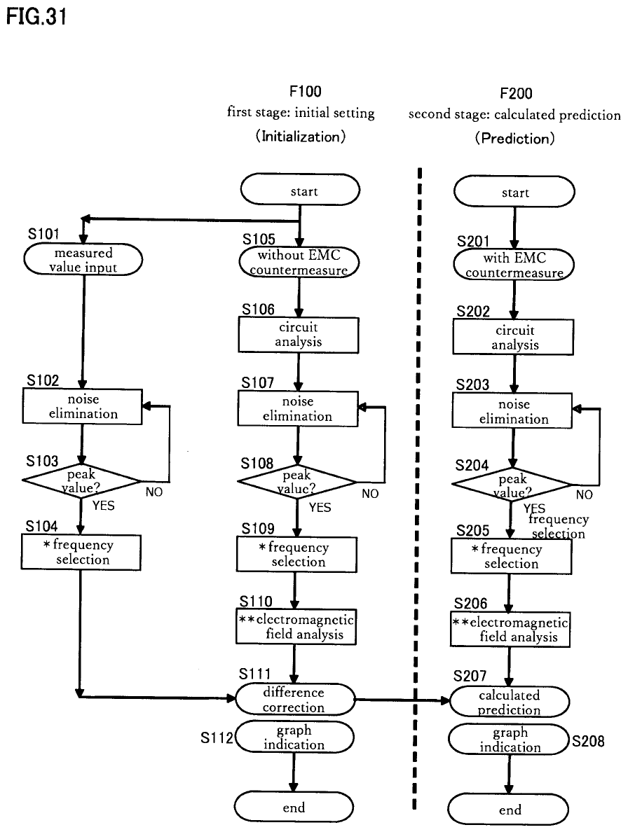

FIG. 31 is a flowchart illustrating an example of an evaluation method for semiconductor integrated circuits. The evaluation method for semiconductor integrated circuits illustrated by the present figure includes an initial setting flow F100 and a calculated prediction flow F200.

The initial setting flow F100 is a flow for obtaining a difference correction value from a measured value and a calculated value of unwanted radiation (e.g., a noise terminal voltage derived from conducted emission or radiated emission) in a semiconductor integrated circuit before implementation of an electromagnetic compatibility (EMC) countermeasure (without an electromagnetic compatibility (EMC) countermeasure), and the flow includes steps S101 to S112, which will be described later.

The calculated prediction flow F200 is a flow for obtaining a calculated value of the unwanted radiation in the semiconductor integrated circuit after the implementation of the electromagnetic compatibility (EMC) countermeasure (with the electromagnetic compatibility (EMC) countermeasure) to correct the calculated value with the difference correction value, and evaluating a corrected calculated value for conformity with a standard, and the flow includes steps S201 to S208, which will be described later.

The initial setting flow F100 and the calculated prediction flow F200 respectively include steps S102, S107 and step S203, these steps each being a step in which noise elimination processing is performed with respect to the measured value and the calculated value of unwanted radiation. Hereinafter, a detailed description will be given of their technical significance.

### <Initial Setting Flow>

When the initial setting flow F100 is started, first, in step S101, measured values of unwanted radiation (conducted emission or radiated emission) in a semiconductor integrated circuit before implementation of electromagnetic compatibility (EMC) countermeasure are inputted.

Next, in step S102, the noise elimination processing is applied to the measured values of the unwanted radiation. The noise elimination processing may be, for example, processing of extracting a peak envelope (an envelope line of peak values) from the measured values of the unwanted radiation.

Note that, in step S103, it is determined whether or not a peak envelope has been correctly extracted. Here, in a case where a YES determination has been made, the flow proceeds to step S104, where frequency selection processing (of which detail will be described later) is performed. On the other hand, in a case where a NO determination has been made, the flow returns to step S102, where the processing of extracting a peak envelope is performed again.

In this manner, depending on the degree of variation in the measured values, the noise elimination processing of step S102 can be repeated a plurality of number of times, thereby to obtain an accurate peak envelope.

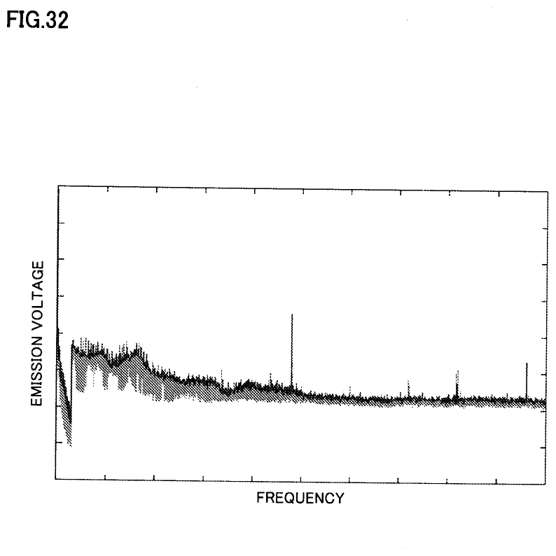

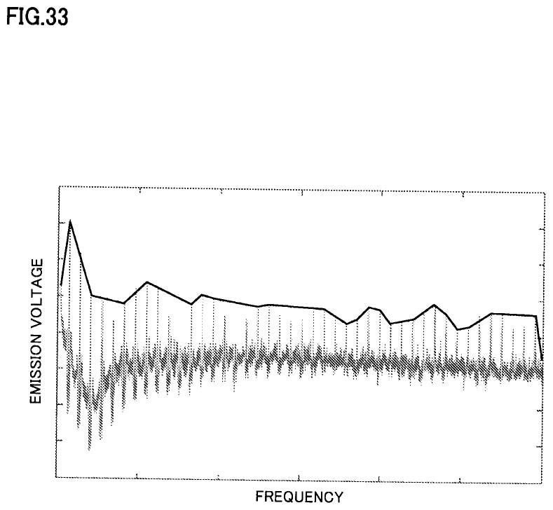

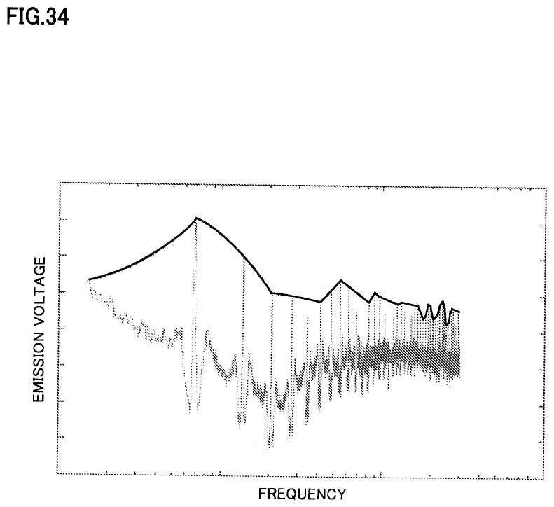

FIG. 32 to FIG. 34 are each a diagram illustrating an example of nose elimination performed with respect to measured values without an electromagnetic compatibility (EMC) countermeasure. A horizontal axis of each figure represents frequency (a linear scale in FIG. 32 and FIG. 33, a logarithmic scale in FIG. 34), and a vertical axis of each figure represents intensity of the unwanted radiation. Further, a gray line represents calculated values (original values) before being subjected to noise elimination, and a black line represents measured values (a peak envelope) having been subjected to noise elimination.

As illustrated in the present figures, through the noise elimination processing of step S102, it is possible to obtain a peak envelope by eliminating floor noise (floor noise) from the measured values of unwanted radiation.

Referring back to FIG. 31, the description of the initial setting flow F100 will be continued. In the initial setting flow F100, in step S105, which is performed in parallel with step S101 described previously, calculated values of the unwanted radiation in the semiconductor integrated circuit before the implementation of the electromagnetic compatibility (EMC) countermeasure are obtained.

Specifically, in step S106, circuit analysis (transient analysis) is performed with respect to the semiconductor integrated circuit before the implementation of the electromagnetic compatibility (EMC) countermeasure, and calculated values of the unwanted radiation is obtained by using an evaluation circuit model for semiconductor integrated circuits.

Next, in step S107, the noise elimination processing is applied to the calculated values of the unwanted radiation. The noise elimination processing may be, for example, processing of extracting a peak envelope (an envelope line of peak values) from the calculated values of the unwanted radiation.

Note that, in step S108, it is determined whether or not a peak envelope has been correctly extracted. Here, in a case where a YES determination has been made, the flow proceeds to step S109, where frequency selection processing (of which detail will be described later) is performed. On the other hand, in a case where a NO determination has been made, the flow returns to step S107, where the processing of extracting a peak envelope is performed again.

Thus, depending on the degree of variation in the calculated values, the noise elimination processing of step S107 can be repeated a plurality of number of times, thereby to obtain an accurate peak envelope.

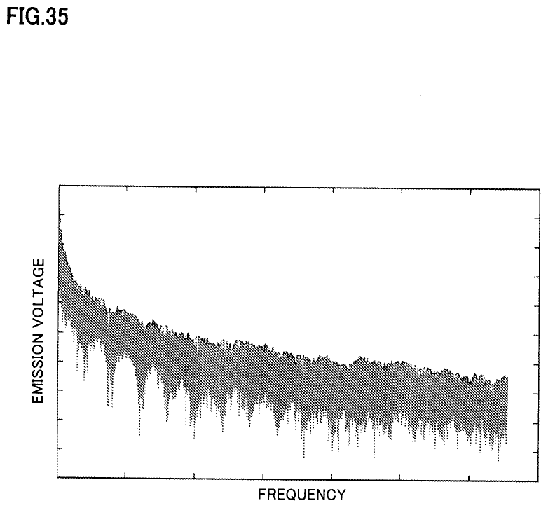

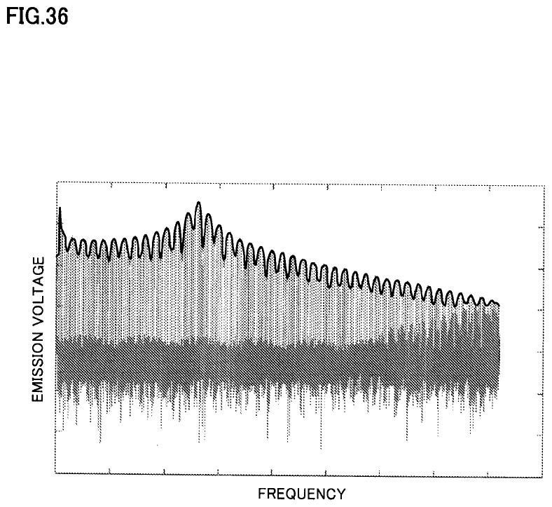

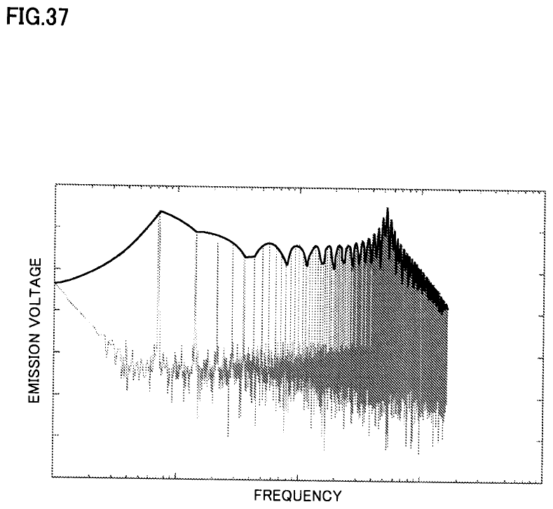

FIG. 35 to FIG. 37 are each a diagram illustrating an example of the noise elimination processing applied to the calculated values without the electromagnetic compatibility (EMC) countermeasure. The horizontal axis of each figure represents frequency (a linear scale in FIG. 35 and FIG. 36, a logarithmic scale in FIG. 37), and the vertical axis of each figure represents intensity of the unwanted radiation. Further, the gray line represents calculated values (original values) before being subjected to noise elimination, and the black line represents calculated values (a peak envelope) having been subjected to noise elimination.

As illustrated in the present figures, through the noise elimination processing of step S107, it is possible to obtain a peak envelope by eliminating floor noise (floor noise) from the calculated values of the unwanted radiation.

Referring back to FIG. 31, the description of the initial setting flow F100 will be continued. In the case where a YES determination has been made in step S103 as mentioned previously, in step S104, a plurality of frequency components are selected from the measured values having been subjected to noise elimination.

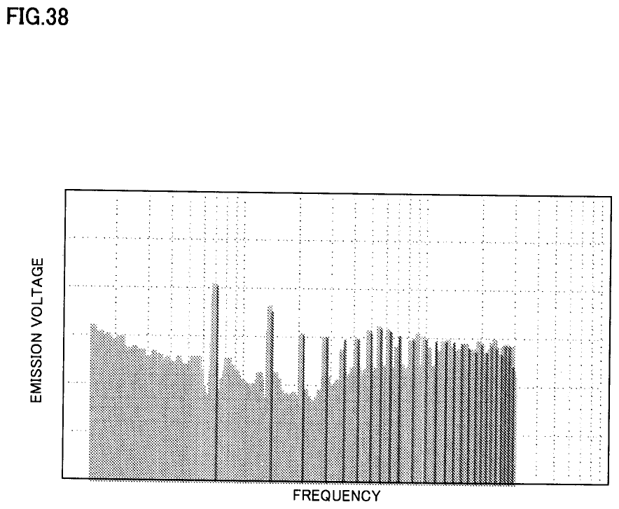

FIG. 38 is a diagram illustrating frequency selection from the measured values having been subjected to noise elimination. A horizontal axis of the present figure represents frequency, and a vertical axis of the present figure represents intensity of the unwanted radiation. Further, a gray line represents measured values having been subjected to noise elimination, and a black line represents selected frequency components. For example, in a case where the semiconductor integrated circuit is a control IC of a switching power supply, N times (corresponding to an Nth harmonic component) of the switching frequency may be selected.

Referring back to FIG. 31, the description of the initial setting flow F100 will be continued. In the case where a YES determination has been made in step S108 as mentioned previously, in step S109, a plurality of frequency components are selected from the calculated values having been subjected to noise elimination. The frequency selection processing here is basically similar to the processing performed in step S104 (FIG. 38) described previously, and thus overlapping descriptions will be omitted.

Subsequently, in step S110, electromagnetic field analysis is performed, as necessary, with respect to the frequency components selected in step S109. The present step is necessary in radiated emission verification, but is not necessary in conducted emission verification.

In step S111, from the measured values and the calculated values from which frequencies have been selected in steps S104 and S109, respectively, difference correction values (=a calculated value-a measured value) are calculated.

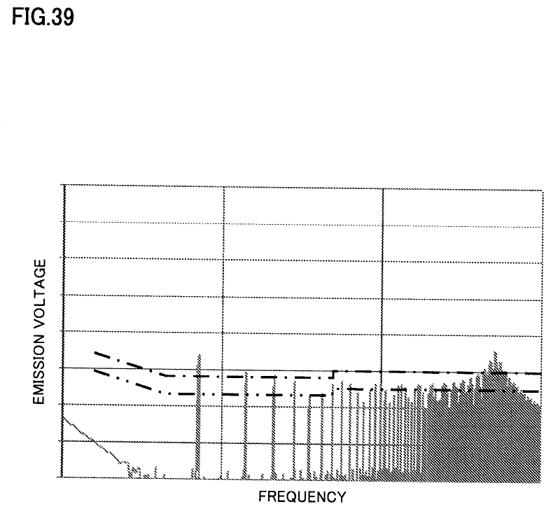

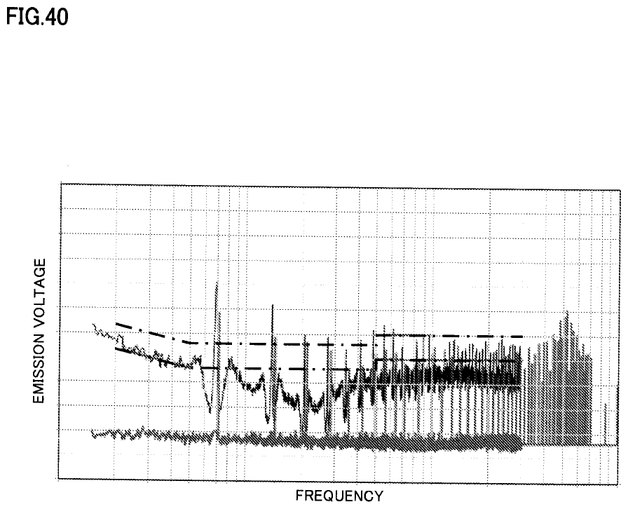

FIG. 39 is a diagram illustrating calculated values (without difference correction) without the electromagnetic compatibility (EMC) countermeasure. The horizontal axis of the present figure represents frequency, and the vertical axis of the present figure represents intensity of unwanted radiation. FIG. 40 is a diagram illustrating measured values and calculated values (without difference correction) without the electromagnetic compatibility (EMC) countermeasure, and the measured values (a black line) are illustrated to be superimposed on the measured values (a gray line) of FIG. 39. In each of the figures, the dashed-and-dotted line and the dashed-and-double-dotted line respectively represent electromagnetic compatibility (EMC) standard limit values.

As is clear from FIG. 40, between the measured values (the black line) and the calculated values without difference correction (the gray line), there are some differences at peak values of the selected frequency components.

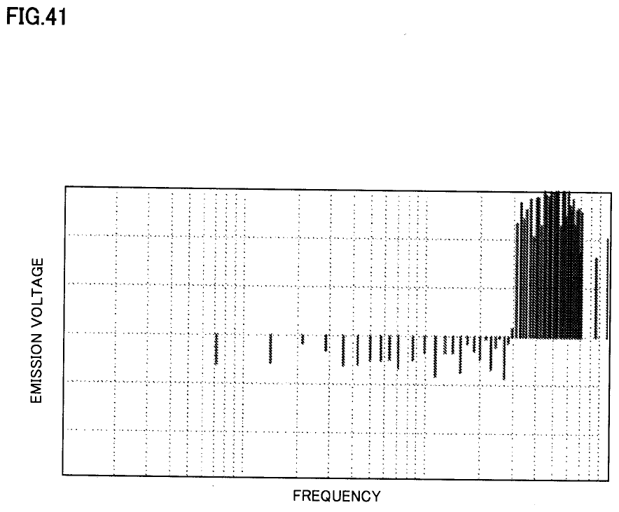

FIG. 41 is a diagram illustrating difference correction values (=a calculated value−a measured value). The difference correction values illustrated in the present figure are obtained by subtracting the measured value from the corresponding calculated value with respect to each of the plurality of frequencies. That is, a difference correction value is negative (<0) when a calculated value is smaller than a corresponding measured value, and is positive (>0) when a calculated value is larger than a corresponding measured value.

Note that, in the present figure, there appear excessive positive difference correction values in a high frequency range. This is due to that, in a high frequency range (e.g., 30 MHz or higher) in FIG. 40, calculated values have been obtained but measured values have not been entered (=0).

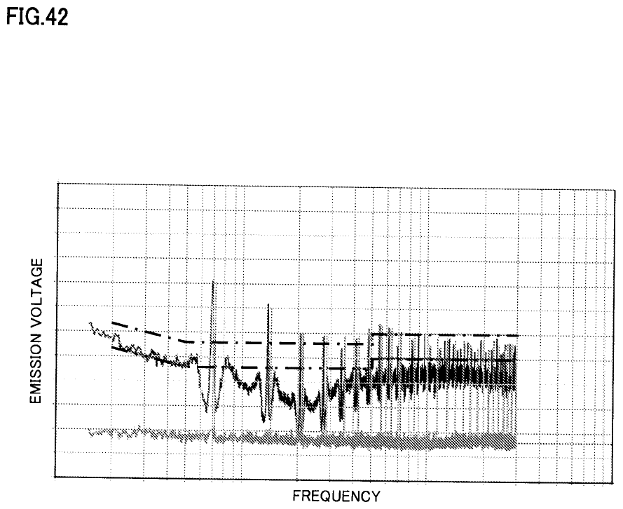

FIG. 42 is a diagram illustrating measured values and calculated values (with difference correction) without the electromagnetic compatibility (EMC) countermeasure. The horizontal axis of the present figure represents frequency, and the vertical axis of the present figure represents intensity of unwanted radiation. The dashed-and-dotted line and the dashed-and-double-dotted line respectively represent electromagnetic compatibility (EMC) standard limit values.

As is clear from the present figure, by applying the difference correction processing to the calculated values using the difference correction values descripted previously, it is possible to bring the calculated values having been subjected to the difference correction (a gray line) into agreement with the measured values (a black line). Note that it is needless to say that the difference correction processing can be performed by subtracting the difference correction values (=a calculated value-a measured value) from the calculated values.

Further, as for FIG. 42, the graph may be indicated in step S112 as necessary. This completes the initial setting flow F100.

Note that it is sufficient to perform the above-described series of initial setting flow F100 only once in electromagnetic compatibility (EMC) characteristics evaluation for a semiconductor integrated circuit.

### <Initial Setting Flow>

Referring back to FIG. 31, a description will be given of the calculated prediction flow F200. When the calculated prediction flow F200 is started, in step S201, calculated values of the unwanted radiation in the semiconductor integrated circuit after the implementation of the electromagnetic compatibility (EMC) countermeasure are obtained.

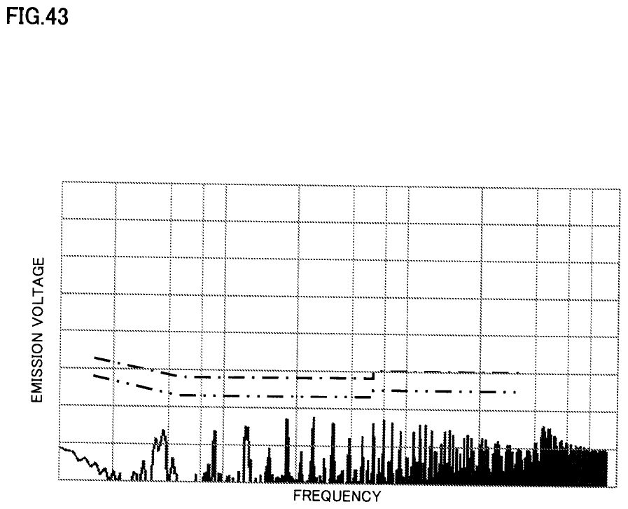

Specifically, in step S202, circuit analysis (transient analysis) is performed with respect to the semiconductor integrated circuit after the implementation of the electromagnetic compatibility (EMC) countermeasure, and the calculated values of the unwanted radiation are obtained using the evaluation circuit model of the semiconductor integrated circuit (see FIG. 43).

FIG. 43 is a diagram illustrating the calculated values (without difference correction) with the electromagnetic compatibility (EMC) countermeasure. The horizontal axis of the present figure represents frequency, and the vertical axis of the present figure represents intensity of unwanted radiation. Further, the dashed-and-dotted line and the dashed-and-double-dotted line respectively represent electromagnetic compatibility (EMC) standard limit values.

Referring back to FIG. 31, the description of the calculated prediction flow F200 will be continued. In step S203, the noise elimination processing is applied to the calculated values of the unwanted radiation. The noise elimination processing may be, for example, processing of extracting a peak envelope (an envelope line of peak values) from the calculated values of the unwanted radiation.

Note that, in step S203, it is determined whether or not a peak envelope has been correctly extracted. Here, in a case where a YES determination has been made, the flow proceeds to step S205, where frequency selection processing (of which detail will be described later) is performed. On the other hand, in a case where a NO determination has been made, the flow returns to step S203, where the processing of extracting a peak envelope is performed again.

In this manner, depending on the degree of variation in the calculated values, the noise elimination processing of step S203 can be repeated a plurality of number of times, thereby to obtain an accurate peak envelope.

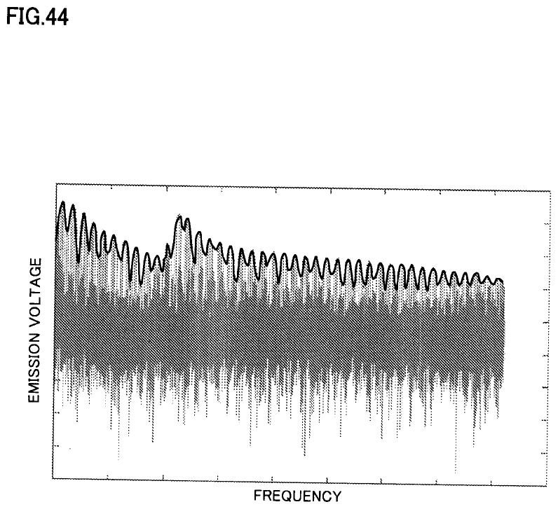

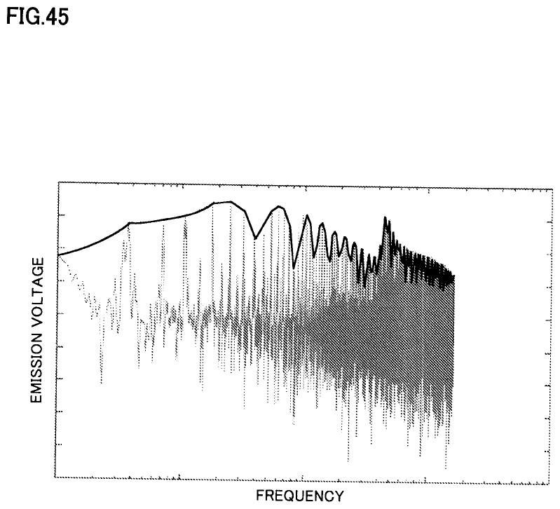

FIG. 44 to FIG. 45 are each a diagram illustrating an example of the noise elimination processing applied to the calculated values with the electromagnetic compatibility (EMC) countermeasure. The horizontal axis of each figure represents frequency (a linear scale in FIG. 44 and a logarithmic scale in FIG. 45), and the vertical axis of each figure represents intensity of the unwanted radiation. Further, the gray line represents calculated values (original values) before being subjected to noise elimination, and the black line represents calculated values (a peak envelope) having been subjected to noise elimination.

As illustrated in the present figures, through the noise elimination processing of step S203, it is possible to obtain a peak envelope by eliminating floor noise (floor noise) from the calculated values of the unwanted radiation.

Referring back to FIG. 31, the description of the calculated prediction flow F200 will be continued. In the case where a YES determination has been made in step S204 as mentioned previously, in step S205, a plurality of frequency components are selected from the calculated values having been subjected to noise elimination. The frequency selection processing here is basically similar to the processing performed in steps S104 and S109 described previously, and thus overlapping descriptions will be omitted.

Subsequently, in step S206, electromagnetic field analysis is performed, as necessary, with respect to the frequency components selected in step S205. The present step is necessary in radiated emission verification, but is not necessary in conducted emission verification. In this respect, the present step is no different from step S110 described previously.

In step S207, the calculated values from which frequencies have been selected in step S205 are corrected with the difference correction values having been calculated in step S111, and evaluation is performed on whether or not the corrected calculated values are in conformity with the standard.

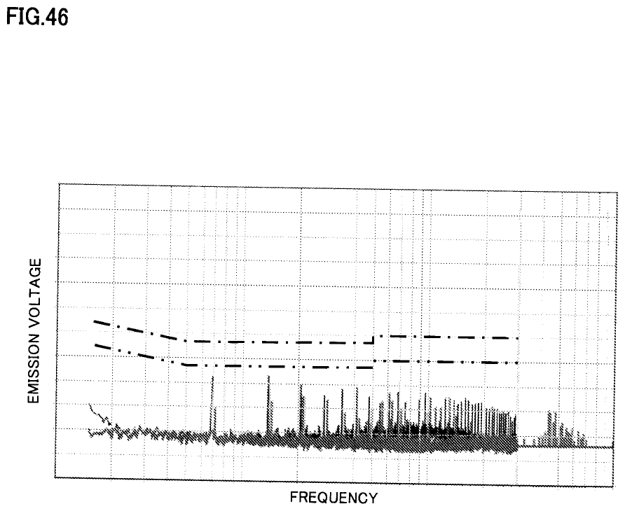

FIG. 46 is a diagram illustrating measured values and calculated values (without difference correction) with the electromagnetic compatibility (EMC) countermeasure. A horizontal axis of the present figure represents frequency, and a vertical axis of the present figure represents intensity of unwanted radiation. Further, a black line represents measured values, and a gray line represents calculated values (without difference correction). Further, a dashed-and-dotted line and a dashed-and-double-dotted line respectively represent electromagnetic compatibility (EMC) standard limit values.

As is clear from the present figure, between the measured values (the black line) and the calculated valued without difference correction (the gray line), there are some differences at peak values of the selected frequency components. This makes it difficult to evaluate the electromagnetic compatibility (EMC) characteristics of the semiconductor integrated circuit with sufficient accuracy by using the calculated values without difference correction (the gray line).

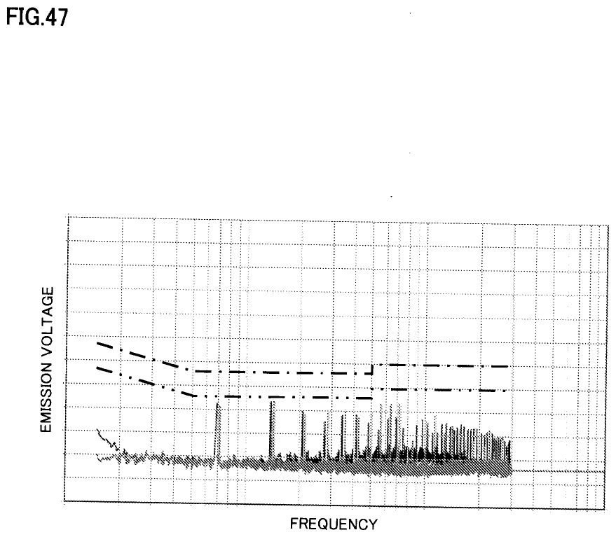

FIG. 47 is a diagram illustrating measured values and calculated values (with difference correction) with the electromagnetic compatibility (EMC) countermeasure. A horizontal axis of the present figure represents frequency, and a vertical axis of the present figure represents intensity of unwanted radiation. Further, a black line represents measured values, and a gray line represents calculated values (with difference correction). Further, a dashed-and-dotted line and a dashed-and-double-dotted line respectively represent electromagnetic compatibility (EMC) standard limit values.

As is clear from the present figure, by applying difference correction processing to the calculated values using the difference correction values descripted previously, it is possible to bring the calculated values having been subjected to the difference correction (the gray line) with the measured values (the black line). Accordingly, use of the calculated values (the gray line) with the difference correction makes it possible to evaluate the electromagnetic compatibility (EMC) characteristics of the semiconductor integrated circuit with sufficient accuracy.

Further, as for FIG. 47, the graph may be indicated in step S208 as necessary. This completes the calculated prediction flow F200.

Note that the series of the calculated prediction flow F200 described above may be repeated a plurality of number of times, with changes to contents of the electromagnetic compatibility (EMC) countermeasure (that is, contents of step S201), until the corrected calculated values come into conformity with the standard.

For example, in a semiconductor integrated circuit without the electromagnetic compatibility (EMC) countermeasure, as illustrated in FIG. 42, the calculated values of the unwanted radiation (the gray line) are above the electromagnetic compatibility (EMC) standard limit values (the dotted-and-dashed line and the dotted-and-double-dotted line). Such a semiconductor integrated circuit is out of conformity with the standard.

On the other hand, in a semiconductor integrated circuit with the electromagnetic compatibility (EMC) countermeasure, as illustrated in FIG. 47, the calculated values of the unwanted radiation (the gray line) are below the electromagnetic compatibility (EMC) standard limit values (the dotted-and-dashed line and the dotted-and-double-dotted line). Such a semiconductor integrated circuit is in conformity with the standard.

### <Technical Significance of Noise Elimination Processing>

In a preliminary calculation verification system for electromagnetic compatibility (EMC), if miscellaneous spectra are included in measured values and calculated values, it is difficult to accurately extract electric power, voltage, and current in specific frequencies. Generally, measured values, which swing up and down, vary greatly due to a small difference in frequency. Thus, differences are caused between measured values and calculated values, which can lead to a critical defect in numerical analysis conducted by using calculated values.

By the way, when people look at data, they focus on peak values unconsciously, thereby eliminating noise components. Knowing this, the inventor of the present application has acquired a novel idea, which led him to development and practical utilization of a completely novel method of applying, to measured values and calculated values of unwanted radiation, noise elimination processing similar to the processing people do when they look at data (e.g., program operation processing of extracting a peak envelope) (see steps S102, S107, and S203 in FIG. 31 referred to previously).

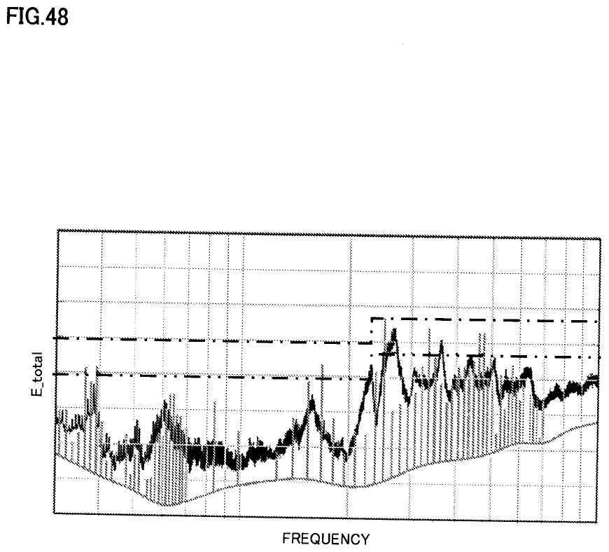

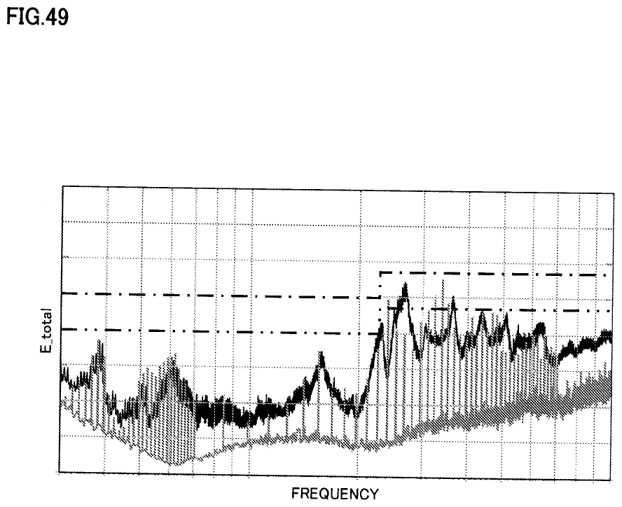

By executing such noise elimination processing, calculated values become accurate (that is, approach measured values which are true values), and thus a good result can be obtained in numerical analysis using calculated values. For example, without the noise elimination processing (FIG. 48), in some frequencies existing in a scattered manner, the measured values (the black line) do not agree with the calculated values (the gray line), but with the noise elimination processing (FIG. 49), the measured values (the black line) agree with the calculated values (the gray line). This contrast has been described previously as well.

### <Evaluation Board for Electromagnetic Compatibility (EMC) Characteristics>

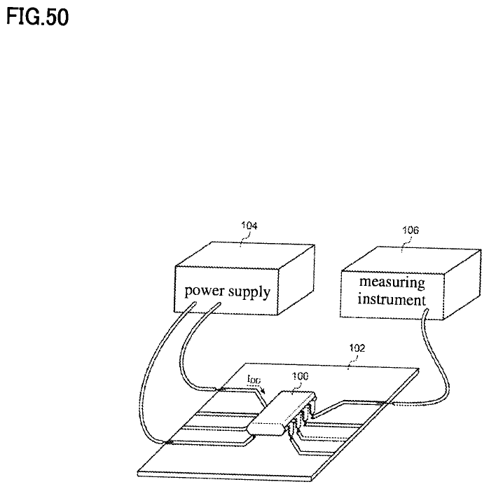

FIG. 50 is a diagram schematically illustrating an evaluation board for electromagnetic compatibility (EMC) characteristics. A semiconductor integrated circuit (hereinafter referred to as IC) 100 as an evaluation target is mounted on an evaluation board 102. Regarding the IC 100, different specifications based on the electromagnetic compatibility (EMC) standards are determined for different usages, and IC vendors design the IC 100 and the evaluation board 102 in accordance with the specifications. In the electromagnetic compatibility (EMC) characteristics evaluation, a power supply 104 and a measuring instrument 106 such as a spectrum analyzer are connected to the evaluation board 102. And, the electromagnetic compatibility (EMC) characteristics evaluation is performed according to a standard procedure, and it is determined whether or not a standard value is satisfied. Then, if a measured value does not satisfy the standard value, the IC 100 and the evaluation board 102 are modified. Vendors repeat this operation until the standard value is satisfied. This point has been described previously.

### <Electromagnetic Compatibility (EMC) Verification Program>

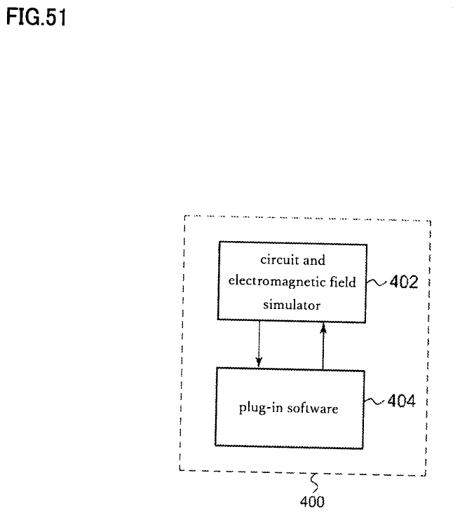

FIG. 51 is a block diagram of an electromagnetic compatibility (EMC) verification program 400. As part of the verification program 400, functions of a commercially available circuit and electromagnetic field simulator 402 can be used as they are, and functions that are not provided by the commercially available circuit and electromagnetic field simulator 402 are realized by an add-in program (plug-in software) 404 for the circuit and the electromagnetic field simulator 402, or by creating new separate software.

### Overview

What follows is an overview of the various embodiments disclosed above.

For example, a semiconductor integrated circuit evaluation method disclosed herein includes an initial setting flow for obtaining a difference correction value from a measured value and a calculated value of unwanted radiation in a semiconductor integrated circuit before implementation of an electromagnetic compatibility countermeasure, and a calculated prediction flow for obtaining a calculated value of unwanted radiation in a semiconductor integrated circuit after implementation of an electromagnetic compatibility measure, correcting the calculated value with the difference correction value, and evaluating whether a corrected value conforms to a standard, wherein the initial setting flow and the calculated prediction flow each include a step of applying noise elimination processing to the measured value and the calculated value of the unwanted radiation (a first configuration).

In the semiconductor integrated circuit evaluation method according to the first configuration described above, the noise elimination processing may be processing of extracting peak envelopes respectively from the measured value and the calculated value of the unwanted radiation (a second configuration).

In the semiconductor integrated circuit evaluation method according to the first or second configuration described above, the noise elimination processing may be repeated a plurality of number of times (a third configuration).

In the semiconductor integrated circuit evaluation method according to any one of the first to third configurations described above, the calculated prediction flow may be repeated a plurality of number of times, with changes to contents of the electromagnetic compatibility countermeasure, until the corrected calculated value conforms to the standard (a fourth configuration).

In the semiconductor integrated circuit evaluation method according to any one of the first to fourth configurations described above, the difference correction value may be obtained for each of a plurality of frequencies (a fifth configuration).

According to the semiconductor integrated circuit evaluation method disclosed herein, it is possible to evaluate the electromagnetic compatibility (EMC) characteristics of semiconductor integrated circuits with sufficient accuracy.

### FURTHER MODIFICATIONS

The various technical features disclosed herein may be implemented in any other manners than in the embodiments described above, and allow for any modifications made without departure from their technical ingenuity. That is, it should be understood that the above embodiments are illustrative in all respects and are not intended to limit the present disclosure, that the technological scope of the present disclosure is indicated by the claims, and that all modifications within the scope of the claims and the meaning equivalent to the claims are covered.

1. A semiconductor integrated circuit evaluation method, comprising:
an initial setting flow for obtaining a difference correction value from a measured value and a calculated value of unwanted radiation in a semiconductor integrated circuit before implementation of an electromagnetic compatibility countermeasure; and
a calculated prediction flow for obtaining a calculated value of unwanted radiation in a semiconductor integrated circuit after implementation of an electromagnetic compatibility countermeasure, correcting the calculated value with the difference correction value, and evaluating whether or not a corrected calculated value conforms to a standard,
wherein
the initial setting flow and the calculated prediction flow each include a step of applying noise elimination processing to the measured value and the calculated value of the unwanted radiation.

2. The semiconductor integrated circuit evaluation method according to claim 1,
wherein
the noise elimination processing is processing of extracting peak envelopes respectively from the measured value and the calculated value of the unwanted radiation.

3. The semiconductor integrated circuit evaluation method according to claim 1,
wherein
the noise elimination processing is repeated a plurality of number of times.

4. The semiconductor integrated circuit evaluation method according to claim 1,
wherein
the calculated prediction flow is repeated a plurality of number of times, with changes to contents of the electromagnetic compatibility countermeasure, until the corrected calculated value conforms to the standard.

5. The semiconductor integrated circuit evaluation method according to claim 1,
wherein
the difference correction value is obtained for each of a plurality of frequencies.
